(19) United States
(12) Patent Application Publication
(10) Pub. No.: US 2026/0081816 A1
(43) Pub. Date: Mar. 19, 2026

(54) TECHNIQUES FOR COMMUNICATION USING A DEMODULATION REFERENCE SIGNAL PATTERN

(71) Applicant: Lenovo (United States) Inc., Morrisville, NC (US)

(72) Inventor: Vahid Pourahmadi, München (DE)

(21) Appl. No.: 19/396,154

(22) Filed: Nov. 20, 2025

(51) Int. Cl. H04L 27/26; H04W 72/0446; H04W 72/115

(52) U.S. Cl. CPC H04L 27/261; H04W 72/0446; H04W 72/115

(57) ABSTRACT

Various aspects of the present disclosure relate to receiving, from a base station, a configuration indicating a demodulation reference signal (DMRS) pattern for a plurality of resource blocks (RBs) or a plurality of time slots, or both, the DMRS pattern comprising different DMRS parameters to be applied across the plurality of RBs or the plurality of time slots, or both; and communicating data with the base station using a transmission grant in accordance with a set of DMRS parameters for each RB or time slot associated with a transmission grant.

### TECHNICAL FIELD

The present disclosure relates to wireless communications, and more specifically to techniques for communicating (e.g., transmitting, receiving, or the like) using a demodulation reference signal (DMRS) pattern, e.g., comprising sets of DMRS parameters for a plurality of resource blocks (RBs) or a plurality of time slots, or both.

### BACKGROUND

A wireless communications system may include one or multiple network communication devices, which may be known as a network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies (RATs) including third generation (3G) radio access technology, fourth generation (4G) radio access technology, fifth generation (5G) radio access technology, among other suitable radio access technologies beyond 5G (e.g., 5G-Advanced (5G-A), sixth generation (6G) radio access technology, etc.).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of″”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A UE for wireless communication is described. The UE may be configured to, capable of, or operable to cause the UE to receive, from a base station, a configuration indicating a DMRS pattern for a plurality of RBs or a plurality of time slots, or both, the DMRS pattern comprising different DMRS parameters to be applied across the plurality of RBs or the plurality of time slots, or both; and communicate data with the base station (e.g., transmit and/or receive the data) using a transmission grant in accordance with the a of DMRS parameters for each RB or time slot associated with the transmission grant.

A processor for wireless communication is described. In certain implementations, the processor may implement, or may be implemented by, a UE. The processor may be configured to, capable of, or operable to receive, from a base station, a configuration indicating a DMRS pattern for a plurality of RBs or a plurality of time slots, or both, the DMRS pattern comprising different DMRS parameters to be applied across the plurality of RBs or the plurality of time slots, or both; and communicate data with the base station (e.g., transmit and/or receive the data) using a transmission grant in accordance with a set of DMRS parameters for each RB or time slot associated with the transmission grant.

A method performed or performable by a UE is described. The method may include receiving, from a base station, a configuration indicating a DMRS pattern for a plurality of RBs or a plurality of time slots, or both, the DMRS pattern comprising different DMRS parameters to be applied across the plurality of RBs or the plurality of time slots, or both; and communicating data with the base station (e.g., transmitting and/or receiving the data) using a transmission grant in accordance with a set of DMRS parameters for each RB or time slot associated with the transmission grant.

A base station for wireless communication is described. The base station may be configured to, capable of, or operable to cause the base station to transmit, to a UE, a configuration indicating a DMRS pattern for a plurality of RBs or a plurality of time slots, or both, wherein the DMRS pattern comprises different DMRS parameters to be applied across the plurality of RBs or the plurality of time slots, or both; and communicate data with the UE (e.g., transmit and/or receive the data) using a transmission grant in accordance with a set of DMRS parameters for each RB or time slot associated with the transmission grant.

A processor for wireless communication is described. The processor may be configured to, capable of, or operable to transmit, to a UE, a configuration indicating a DMRS pattern for a plurality of RBs or a plurality of time slots, or both, wherein the DMRS pattern comprises different DMRS parameters to be applied across the plurality of RBs or the plurality of time slots, or both; and communicate data with the UE (e.g., transmit and/or receive the data) using a transmission grant in accordance with a set of DMRS parameters for each RB or time slot associated with the transmission grant.

A method performed or performable by a base station is described. The method may include transmit, to a UE, a configuration indicating a DMRS pattern for a plurality of RBs or a plurality of time slots, or both, wherein the DMRS pattern comprises different DMRS parameters to be applied across the plurality of RBs or the plurality of time slots, or both; and communicate data with the UE (e.g., transmitting and/or receiving the data) using a transmission grant in accordance with a set of DMRS parameters for each RB or time slot associated with the transmission grant.

### BRIEF DESCRIPTION OF THE DRAWINGS

FIG. 1 illustrates an example of a wireless communications system, in accordance with aspects of the present disclosure.

FIGS. 2-4 illustrate examples of DMRS patterns, in accordance with aspects of the present disclosure.

FIG. 5 illustrates an example of a protocol stack, in accordance with aspects of the present disclosure.

FIG. 6 illustrates an example of a UE, in accordance with aspects of the present disclosure.

FIG. 7 illustrates an example of a processor, in accordance with aspects of the present disclosure.

FIG. 8 illustrates an example of a NE, in accordance with aspects of the present disclosure.

FIG. 9 illustrates a flowchart of a method performed by a UE in accordance with aspects of the present disclosure.

FIG. 10 illustrates a flowchart of a method performed by a NE in accordance with aspects of the present disclosure.

### DETAILED DESCRIPTION

A wireless communication system may support transmission of data over a physical downlink shared channel (PDSCH) and physical uplink shared channel (PUSCH). In 5G new radio (NR) systems, DMRS are essential for enabling coherent demodulation of data transmitted over the PDSCH and PUSCH. The receiver (e.g., a UE for a PDSCH transmission or a NE for a PUSCH transmission) uses the DMRS to estimate the radio channel, which is necessary for equalization, decoding, and link adaptation.

For downlink (DL) data (i.e., transmitted on the PDSCH), the NE may configure the UE with a DMRS pattern, e.g., via radio resource control (RRC) signaling, and the UE performs channel estimation using the signals received in resources corresponding to the configured DMRS pattern. Similarly, for uplink (UL) data (i.e., transmitted on the PUSCH), the NE may configure the UE with a DMRS pattern (e.g., via RRC signaling), and the NE performs channel estimation using the signals received in resources corresponding to the configured DMRS pattern.

The UE may determine its DMRS configuration (i.e., for DL and/or UL communications) by a combination of higher-layer signaling (via RRC) and dynamic scheduling (e.g., via downlink control information (DCI) which the NE transmits on the physical downlink control channel (PDCCH)). In certain implementations, the DMRS pattern may be tightly coupled to the active bandwidth part (BWP) at the time of transmission. As used herein, “DMRS configuration” refers to parameters for the transmission (or reception) of DMRS for UL and/or DL communications, including mapping type, repetition/periodicity type, the number of DMRS symbols, the number of resource elements (REs) occupied by DMRS, DMRS positions, sequence generation, scrambling identifiers (IDs) waveform type, transform precoding, and the like. Similarly, the term “DMRS pattern” refers to the pattern of time and frequency resources (e.g., REs) allocated for communication of DMRS during the uplink and/or downlink communication. For a given UE, the DMRS configuration and/or DMRS pattern may differ for DL communications versus UL communications.

Conventional receivers rely on deterministic DMRS patterns to perform channel estimation, where the DMRS patterns are typically fixed across all resource blocks (RBs) within a transmission. For example, in mapping type A, DMRS may be placed on symbol 2 and symbol 11 in every RB that is assigned for transmission/reception. This uniformity simplifies configuration and receiver design and ensures consistent channel estimation performance. The UE extracts DMRS symbols from the received signal and interpolates the channel response across the entire set of resource elements (REs). This approach assumes that the channel is sufficiently sampled and that the DMRS density is adequate to capture the channel variations. Consequently, the system is designed to ensure that DMRS is present in all RBs, even when the channel conditions do not require such density. However, this uniformity may also lead to significant overhead, especially in scenarios with favorable channel conditions or low mobility where dense DMRS is not necessary.

Moreover, recent advancements in artificial intelligence (AI) and/or machine learning (ML) based receivers show potential for performance improvement. AI-based channel estimation techniques can infer the full channel state from sparse DMRS patterns. These receivers use learned models to interpolate channel conditions across REs, potentially enabling accurate estimation even when DMRS is transmitted sparsely or irregularly. This capability introduces a new degree of flexibility in DMRS design and opens the possibility for reducing DMRS overhead without compromising channel estimation accuracy.

When AI-based estimation is available, the receiver is no longer constrained by the need for uniform and dense DMRS patterns. It can tolerate variations in DMRS placement across RBs and even the absence of DMRS in selected RBs. This flexibility is not supported in conventional radio access networks (RANs), which assume that all RBs in a scheduled transmission (at least within the same BWP) carry DMRS according to the configured pattern. This rigidity leads to unnecessary overhead, especially in scenarios with favorable channel conditions or advanced receiver capabilities.

The present disclosure provides techniques for improving DMRS placement for communication (e.g., transmission, reception) of a transmission block (TB) comprising user data and/or control data and techniques for reducing the DMRS overhead while supporting flexible DMRS placement by the NE configuring a UE with a DMRS pattern for more than one RB and/or more than one time slot associated with a transmission grant (e.g., the pattern spanning multiple RBs and/or multiple time slots). A NE may transmit, and a UE may receive, a configuration (e.g., a DMRS configuration) indicating a DMRS pattern for a plurality of RBs or a plurality of time slots, or both, where the DMRS pattern comprises different DMRS parameters to be applied across the plurality of RBs or the plurality of time slots, or both. By way of example, the DMRS configuration may indicate a single transmission grant comprising the plurality of RBs and the plurality of time slots, such that the DMRS pattern is associated with the single transmission grant. Additionally, or alternatively, the DMRS pattern may be associated with a particular BWP, where the transmission grant is within the particular BWP.

The UE may transmit, and the NE may receive, UL data using the transmission grant and in accordance with a set of DMRS parameters determined for each RB or time slot of the transmission grant. Additionally, or alternatively, the NE may transmit, and the UE may receive, DL data using the transmission grant and in accordance with a set of DMRS parameters determined for each RB or time slot of the transmission grant. By enabling (e.g., configuring) a DMRS pattern for multiple RBs and/or multiple time slots—with variations in the DMRS parameters to be applied across the RBs and/or time slots, the UE and NE may reduce DMRS overhead while improving DMRS placement for communication (e.g., transmission, reception) of a TB using the transmission grant.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

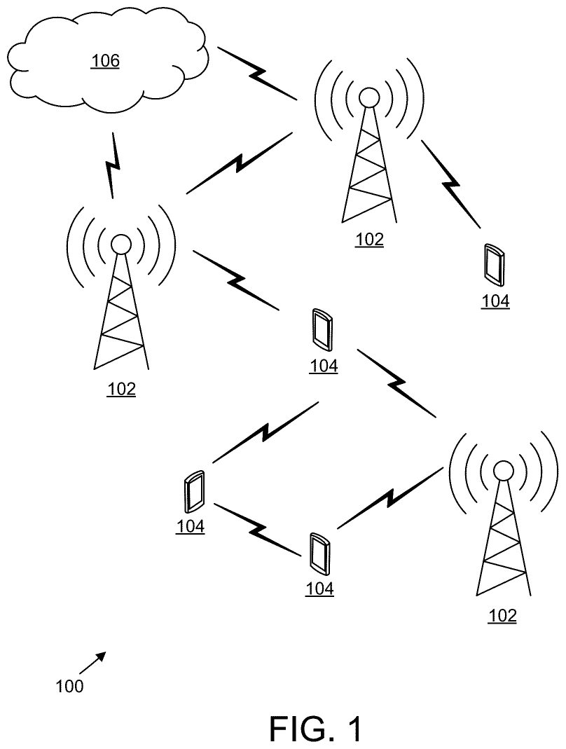

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various RATs. In some implementations, the wireless communications system 100 may be a 4G network, such as a long-term evolution (LTE) network or an LTE-Advanced (LTE-A) network. In some other implementations, the wireless communications system 100 may be an NR network, such as a 5G network, a 5G-Advanced (5G-A) network, or a 5G ultrawideband (5G-UWB) network. In some other implementations, the wireless communications system 100 may be a 6G radio (6GR) network, such as a 6G network. In other implementations, the wireless communications system 100 may be a combination of a 4G network and/or a 5G network and/or a 6G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6GR. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a wireless communication network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an IoT device, an internet-of-everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, X2, N2, N3, Xn, F1-C, F1-U, or another network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, X2, N2, N3, Xn, F1-C, F1-U, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing (SCS) value and a cyclic prefix. A first numerology (e.g., μ=0) may be associated with a first SCS value (e.g., 15 kHz) and a normal cyclic prefix. In some implementations, the first numerology (e.g., μ=0) associated with the first SCS value (e.g., 15 kHz) may utilize one slot per subframe. A second numerology (e.g., μ=1) may be associated with a second SCS value (e.g., 30 kHz) and a normal cyclic prefix. A third numerology (e.g., μ=2) may be associated with a third SCS value (e.g., 60 kHz) and a normal cyclic prefix or an extended cyclic prefix. A fourth numerology (e.g., μ=3) may be associated with a fourth SCS value (e.g., 120 kHz) and a normal cyclic prefix. A fifth numerology (e.g., μ=4) may be associated with a fifth SCS value (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 millisecond (msec) duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective SCS values of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz SCS), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first SCS value (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations frequency range #1 (FR1) (e.g., 410 MHz-7.125 GHz), frequency range #2 (FR2) (e.g., 24.25 GHz-52.6 GHz), frequency range #3 (FR3) (e.g., 7.125 GHz-24.25 GHz), frequency range #4 (FR4) (e.g., 52.6 GHz-114.25 GHz), frequency range #4a (FR4a) or frequency range #4-1 (FR4-1) (e.g., 52.6 GHz-71 GHz), and frequency range #5 (FR5) (e.g., 114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz SCS; a second numerology (e.g., μ=1), which includes 30 kHz SCS; and a third numerology (e.g., μ=2), which includes 60 kHz SCS. FR2 may be associated with one or multiple numerologies (e.g., at least 2 numerologies). For example, FR2 may be associated with a third numerology (e.g., μ=2), which includes 60 kHz SCS; and a fourth numerology (e.g., μ=3), which includes 120 kHz SCS.

In the wireless communication system 100, an NE 102 may transmit, and a UE 104 may receive, a configuration (e.g., DMRS configuration) indicating a DMRS pattern for a plurality of RBs or a plurality of time slots, or both (e.g., the pattern spanning multiple RBs and/or multiple time slots). In some implementations, the DMRS pattern includes different DMRS parameters to be applied across the plurality of RBs or across one or more groups of RBs. In some implementations, the DMRS pattern includes different DMRS parameters to be applied across the plurality of time slots or across one or more groups of time slots.

The NE 102 or the UE 104 may communicate data (e.g., transmitting and/or receiving UL data and/or DL data) using a transmission grant in accordance with a set of DMRS parameters for each RB or time slot associated with a transmission grant. In some implementations, the NE 102 or the UE 104 may determine the set of DMRS parameters, e.g., based on the DMRS configuration.

For DL data (i.e., PDSCH transmission), the NE 102 configures DMRS patterns through RRC signaling, and then transmits DMRS in accordance with the configured DMRS patterns. The UE 104 uses the DMRS patterns to receive the DMRS and perform channel estimation. Key aspects of the DL DMRS configuration include: the mapping type, the DMRS configuration type, the number of DMRS symbols, additional DMRS positions, the sequence generation and the scrambling IDs.

DMRS mapping Types A and B refer to different time domain locations of the initial DMRS relative to the data transmission, e.g., for PDSCH and PUSCH. Third Generation Partnership Project (3GPP) NR defines Mapping Type A as slot-aligned (i.e., full slot transmission), which is useful when allocations often span most or all of the slot duration. In mapping Type A, the first DMRS symbol location is determined relative to the start of the slot (i.e., OFDM symbol 0) regardless of where the actual data transmission begins within the slot. Here, the first DMRS symbol is typically in symbol 2 or symbol 3 of the slot. In contrast, 3GPP NR defines Mapping Type B as non-slot-aligned, where the first DMRS slot location is determined relative to the start of the PDSCH (or PUSCH). Here, the first DMRS symbol is always located in the first allocated symbol of the TB, which may allow the PDSCH to start later in the slot.

DMRS configuration Types 1 and 2 refer to different ways the DMRS is mapped to REs in the frequency domain, e.g., for PDSCH and PUSCH. 3GPP defines DMRS configuration Type 1 as a pattern occupying every 2nd subcarrier in the allocated RB (e.g., with 6 DMRS REs per RB per symbol for a 12 subcarrier RB) and supports up to 8 DMRS ports (sufficient for up to 8-layer multiple-input multiple-output (MIMO)). In contrast, 3GPP defines DMRS configuration Type 2 as a lower density pattern (every 3rd pair of subcarriers, effectively 4 REs per RB per symbol for a 12 subcarrier RB) that allows up to 12 orthogonal DMRS ports for higher-layer MIMO. DMRS configuration Type 2 (i.e., dmrs-type=‘type2’) uses fewer REs for DMRS per RB, thus consuming less overhead than DMRS configuration Type 1 (i.e., dmrs-type=‘type1’). In certain implementations, Type 1 is the default value, for example where the DMRS configuration parameter dmrs-type is not present (i.e., not explicitly configured).

Regarding the number of DMRS symbols configured, 3GPP NR allows the DMRS to span one or two OFDM symbols in the slot. In certain implementations, the configuration parameter maxLength is used to indicate the configured number of DMRS symbols, using the possible values of “len1” and “len2”. Single-symbol DMRS (indicated by value “len1”) is the default case and is often adequate for UEs 104 with low- to mid-mobility. Single-symbol DMRS uses less overhead but supports fewer antenna ports (e.g., up to 8). Double-symbol DMRS indicated by value “len2”) is an optional implementation where the DMRS spans two consecutive symbols. Double-symbol DMRS provides better channel estimation and supports more antenna ports (e.g., up to 12), but uses more overhead. In certain implementations, ‘len1’ is the default value, for example where the DMRS configuration parameter maxLength is not present (i.e., not explicitly configured).

Regarding additional DMRS positions, beyond the first DMRS symbol (e.g., at l0), the NE 102 may configure up to 3 additional DMRS symbols in the slot, e.g., to boost pilot time density for high Doppler scenarios. The dmrs-AdditionalPosition parameter sets the maximum number of additional DMRS symbols that can be transmitted within a scheduled data slot. The dmrs-AdditionalPosition parameter can be set to one of the following values: pos0 (or 0); pos1 (or 1); pos2 (or 2); or pos3 (or j3′). In certain implementations, ‘pos2’ is the default value, for example where the DMRS configuration parameter dmrs-AdditionalPosition is not present (i.e., not explicitly configured).

The value ‘pos0’ (or just ‘0’) means zero additional DMRS positions are configured, resulting in only the initial DMRS symbol being present. The value pos1 (or just ‘1’) configures up to one additional DMRS position in the slot. The value ‘pos2’ (or just ‘2’) configures up to two additional DMRS positions. The value ‘pos3’ (or just ‘3’) configures up to three additional DMRS positions, thus providing the highest density of DMRS symbols over time.

In some implementations, the actual number of DMRS symbols to be used in a particular transmission grant can be dynamically indicated in the DCI message scheduling the grant, up to the maxLength value configured via RRC. The total number of DMRS symbols in a slot can be further increased by the dmrs-AdditionalPosition parameter, which adds additional DMRS symbols later in the slot, up to a maximum of 4 DMRS symbols in total.

All DMRS are generated from pseudo-random sequences known to both transmitter and receiver. The NE 102 and/or UE 104 may generate the DMRS sequence once per slot across the BWP, where the generated sequence is mapped only to the specific RBs allocated for data transmission (e.g., on the PDSCH and/or PUSCH). The DMRS scrambling ID is a parameter controlling the sequence generation and is useful for distinguishing DMRS sequences between different cells, users, and even different data streams within a cell. The NE 102 may configure a UE 104 with a DMRS scrambling ID for generating an orthogonal sequence. In certain implementations, the NE 102 may configure a UE 104 with a pair of DMRS scrambling IDs (i.e., scramblingID0 and scramblingID1) and the UE 104 may generate two codewords, each codeword corresponding to one of the two DMRS scrambling IDs.

In some implementations, the NE 102 may convey all these parameters for DL DMRS to the UE 104 through RRC messages. Typically, the initial serving cell configuration (e.g., sent by the NE 102 in a RRCConnectionSetup message for 5G standalone (SA) mode or via the MasterCellGroup in EN-DC for non-standalone (NSA) mode) includes a configuration spCellConfig with a DownlinkBWP configuration. In certain implementations, the DMRS parameters may be contained in an information element (IE) dmrs-DownlinkForPUSCH located in the IE PDSCH-Config of the DownlinkBWP configuration.

In some implementations, the DL DMRS configuration (e.g., PDSCH-Config IE) may also include the parameter NumCDMGroupsWithoutData which refers to the number of DMRS code division multiplexing (CDM) groups that are reserved exclusively for DMRS transmission and not used for data. In certain implementations, this parameter is not explicitly signaled in RRC or DCI messages but is instead derived by the UE 104 based on a combination of configuration and scheduling context. Specifically, the UE 104 may determine the value of the parameter NumCDMGroupsWithoutData using factors such as the DMRS type (i.e., Type 1 or Type 2), the maxLength of DMRS symbols (i.e., len1 or len2), whether transform precoding is enabled or disabled, the number of transmission layers (i.e., rank), and the scheduling format (e.g., DCI format 0_0 or 0_1).

Regarding the dynamic DL control signaling of DL DMRS parameters (e.g., via DCI), after the NE 102 transmits the RRC configuration to a UE 104, every PDSCH scheduled to that UE 104 may carry an associated DCI grant (typically on PDCCH). In addition to indicating the resource allocation and MCS, the DCI (e.g., DCI format 1_0 for single-layer, or DCI format 1_1 for multi-layer) may provide additional information needed to determine the DMRS pattern. In one implementation, for single-layer (DCI 1_0), no explicit DMRS indication is given; rather, the UE 104 just uses the RRC-configured pattern (with single-symbol DMRS, Type 1 by default). In another implementation, for multi-layer (DCI 1_1), the DCI may include an antenna port indicator and DMRS configuration index that informs the UE 104 about the layer mapping of the transmission grant, and whether double-symbol DMRS is used.

For UL data (i.e., PUSCH transmission), the NE 102 configures DMRS patterns through RRC signaling, and the UE 104 transmits DMRS in accordance with the configured DMRS patterns. The NE 102 uses the DMRS patterns to receive the DMRS and perform channel estimation. Key aspects of the UL DMRS configuration include: the mapping type, the DMRS configuration type, the number of DMRS symbols, additional DMRS positions, the sequence generation and the scrambling IDs.

The DMRS configuration for UL (i.e., PUSCH) transmission also may have DMRS mapping Types A and B, analogous to the DL DMRS configuration.

The DMRS configuration for UL (i.e., PUSCH) transmission also may have DMRS configuration Types 1 and 2, with the same frequency domain patterns as in the DL DMRS configuration (e.g., Type 1=6 REs per RB per symbol, Type 2=4 REs per RB per symbol).

Regarding the number of DMRS symbols configured, the UL DMRS configuration may also include the configuration parameter maxLength to indicate the configured number of DMRS symbols, using the possible values of “len1” and “len2”. Similar to the downlink case, in the uplink the actual number of DMRS symbols to be used in a particular transmission grant can be dynamically indicated in the DCI message scheduling the UL grant, up to the maxLength value configured via RRC.

Regarding additional DMRS positions, the UL DMRS configuration may also include the parameter dmrs-AdditionalPosition to configure up to 3 additional DMRS symbols in the slot.

The DMRS configuration for UL (i.e., PUSCH) transmission also includes the DMRS scrambling ID parameter to control the generation of the DMRS sequence, analogous to the DL DMRS configuration.

In certain implementations, the DMRS configuration for UL (i.e., PUSCH) transmission also indicates whether a phase tracking RS (PTRS) is configured, and if so, may include an IE with UL PTRS configuration parameters.

In some implementations, the NE 102 may convey all these parameters for UL DMRS to the UE 104 through RRC messages. For example, the initial serving cell configuration may include an UplinkBWP configuration. In certain implementations, the NE 102 may provide (to the UE 104) the DMRS parameters in an IE dmrs-UplinkForPUSCH located inside the IE PDSCH-Config of the UplinkBWP configuration. As another example, the NE 102 may transmit (to the UE 104) an RRCReconfiguration message with the IE PDSCH-Config that contains the UL DMRS configuration (i.e., DMRS-UplinkConfig IE). In some implementations, the NE 102 may separately define a respective DMRS-UplinkConfig IE for DMRS mapping Type A and Type B, since both DMRS mapping Type A and Type B can use the same or different DMRS setups.

In some implementations, the NE 102 may configure the UE 104 with a DMRS-UplinkConfig IE that indicates a baseline UL DMRS configuration, e.g., DMRS Type 1 pattern (i.e., ‘type1’), single-symbol DMRS (i.e., ‘len1’), with no extra DMRS positions (i.e., ‘pos0’). In one example, the baseline UL DMRS configuration may set the parameter transformPrecoding to ‘disabled,’ and thus the parameter transformPrecodingDisabled would be present and indicate the scrambling IDs, e.g., scramblingID0=19, and scramblingID1=19. However, in another example, the parameter transformPrecoding may instead be set to ‘enabled,’ and thus the parameter transformPrecodingEnabled would be present and the UL DMRS configuration would omit the scrambling IDs and instead include the transformPrecodingEnabled sequence (e.g., with an nPUSCH-Identity and hopping flags) to define the Zadoff-Chu sequence parameters.

Regarding the DL control signaling of UL DMRS parameters, after the NE 102 transmits the RRC configuration with UL DMRS parameters to a UE 104, a UL PUSCH transmission may be scheduled dynamically by DCI (Format 0_0 or 0_1) or configured semi-persistently via configured grants, which are an uplink equivalent of semi-persistent scheduling.

For dynamic grants via DCI format 0_1 (which supports indicating up to 2 antenna layers), the NE 102 may transmit to the UE 104 a DCI that may include an UL DMRS field similar to the DL case. The UL DMRS field in DCI may indicate the DMRS sequence initialization identify (i.e., N_{SCID} bit for PUSCH, a scrambler toggle) and optionally the number of DMRS symbols, e.g., if transform precoding is disabled and maxLength=‘len2’ is configured. In 5G NR, the DCI format 0_1 has bits to indicate the UL antenna port(s) or DMRS port set used by the UE 104, implicitly informing the NE 102 of how to interpret the DMRS ports and thus the layer mapping.

For Configured Grants (CG), the NE 102 may transmit to the UE 104 a dedicated configuration to send PUSCH at predetermined intervals without a DCI trigger. In that case, the DMRS pattern to use for those transmissions is fully specified in the RRC configuration. The RRC ConfiguredGrantConfig (e.g., part of the PUSCH-ConfigCommon configuration or the SchedulingRequestConfig configuration) may contain parameters like the periodicity and resource allocation of the CG, and a reference to a CG-specific DMRS configuration (e.g., also referred to as cg-DMRS-Configuration) with the DMRS parameters for a baseline UL DMRS configuration as described above.

In some implementations, the time domain configuration for CG-specific DMRS configuration may be provided through several fields of the RRC ConfiguredGrantConfig. For example, the field timeDomainAllocation may provide a row index pointing to a time domain resource allocation table. The selected row defines: A) the start symbol; B) the length of the allocation; C) the mapping type (Type A or B); and D) the number of repetitions (if applicable). As another example, the fields cg-nrofSlots and cg-nrofPUSCH-InSlot may define how many consecutive slots are allocated within a grant period and how many PUSCH transmissions occur within each slot. As yet another example, the field periodicity may indicate how often the configured grant repeats; possible values range from short durations (e.g., sym2) to long durations (e.g., sym5120×14) depending on the subcarrier spacing.

In some implementations, the frequency domain configuration for CG-specific DMRS configuration may be provided through several fields of the RRC ConfiguredGrantConfig. For example, the field frequencyDomainAllocation may provide a bit-string that defines which PRBs are allocated for transmission. As another example, the field resourceAllocation may specify the resource allocation type, e.g., resourceAllocationType0 (i.e., using a bitmap to indicate allocated PRBs), resourceAllocationType1 (i.e., using resource indication value (RIV) encoding to indicate allocated PRBs, and/or dynamicSwitch (i.e., allowing switching between resourceAllocationType0 and resourceAllocationType1. As yet another example, the fields frequencyHoppingOffset and frequencyHopping may be used to enable intra-slot or inter-slot frequency hopping, which affects how subcarriers are used across repetitions.

Traditional channel estimation in wireless systems rely heavily on DMRS pilot signals. Once the NE 102 and/or UE 104 identify the DMRS REs as described above, they can estimate the channel coefficients on those REs and interpolate and/or extrapolate the estimated channel conditions to the data REs (i.e., non-DMRS REs carrying user data or control plane signaling other than an RS transmission).

The performance of channel estimation depends on pilot signal density (e.g., DMRS density) and channel dynamics. For example, if the channel varies slowly in frequency (i.e., relative to pilot spacing), then a sparse pilot grid is suitable; however, if the channel varies rapidly (e.g., frequency-selective fading with many nulls in between), then increased pilot signal density or a more sophisticated interpolator is needed. As another example, if the channel varies slowly in time (e.g., low Doppler), one pilot symbol per slot might suffice; however, if the channel varies quickly in time (e.g., due to a high-speed UE), then multiple DMRS symbols per slot are needed to “sample” the channel at different times for interpolation.

Two common estimation techniques used in 5G NR receivers include the least squares (LS) estimation and the linear minimum mean square error (LMMSE) estimation. LMMSE is a more advanced technique that uses statistical models of the channel and noise to improve estimation. The idea is to filter or smooth the raw LS estimates using a weighting matrix that minimizes the mean-square error.

In some implementations, a receiver may implement Kalman filtering (i.e., for time tracking). For example, in high-Doppler scenarios, if pilot symbols are scattered in time (e.g., only at slot beginning and midpoint), then a time-domain Kalman filter can track the channel variation over OFDM symbols between pilot symbols. As such, Kalman filtering can be viewed as a form of LMMSE applied sequentially (assuming a time correlation model).

In some implementations, a receiver may implement AI-based channel estimation. For example, a neural network may learn to infer the channel state from limited pilot signals and/or the received data symbols. The AI-based receiver may be implemented at the NE 102 and/or the UE(s) 104.

Apart from using AI for channel estimation, there are additional AI schemes that may determine optimal pilot patterns. For example, if the UE 104 can evaluate how well it estimated the channel, then the 104 may feedback this information to the NE 102 for adjusting future pilot signal density. Another concept is for the UE 104 to use an AI model to suggest an improved DMRS pattern to the 102, e.g., based on the current channel conditions. For example, the UE 104 might infer that “the channel was smooth enough that not all pilots were needed in every RB or every symbol” and could report an “optimal downlink DMRS pattern” to the NE 102.

In current 5G NR systems, DMRS patterns are configured via higher-layer signaling (e.g., RRC) and dynamic scheduling (e.g., DCI), and are typically fixed across all RBs within a transmission occasion. For example, in mapping type A, the DMRS may be placed on symbol 2 and symbol 11 in every RB. This uniformity simplifies receiver design but leads to significant overhead, especially in scenarios with favorable channel conditions or low mobility where dense DMRS is not necessary.

Recent advancements in AI-based receivers have demonstrated the ability to perform accurate channel estimation using sparse DMRS patterns. These AI-based receivers can interpolate channel conditions across REs using learned models, enabling robust performance even when DMRS is transmitted irregularly or omitted in selected RBs. This capability opens the door to more flexible DMRS designs that adapt to channel conditions and receiver capabilities. Accordingly, the present disclosure provides techniques for improved indication of DMRS patterns, thereby expanding the set of DMRS patterns that can be selected and supported by the system.

In current 5G NR systems, the DMRS configuration determines how DMRS is transmitted within one RB. Depending on the DMRS-Config parameters, the UE 104 and NE 102 understand which subcarriers and symbols are reserved for DMRS. The available configurations support: A) 1 to 4 DMRS symbols per slot (via maxLength and dmrs-AdditionalPosition); B) Frequency-domain density: Type 1 (every 2nd subcarrier) and Type 2 (every 3rd pair of subcarriers); C) whether single-symbol or double-symbol DMRS; D) a variable number of DMRS ports depending on the number of layers; and/or E) the scrambling sequence used for generation of the DMRS.

Each configuration offers a trade-off between channel estimation quality and overhead. One way to balance this trade-off is to adapt the DMRS pattern based on feedback such as channel state information (CSI) reports, prior transmission results, or UE mobility estimates. For instance, the precoding matrix indicator (PMI) can indicate frequency selectivity, which can guide the selection of DMRS frequency-domain density. The PMI is feedback sent by the UE 104 to the NE 102, e.g., as part of a CSI feedback report in systems using MIMO communications.

Although switching between DMRS patterns across transmission grants is possible via RRC or DCI signaling, current specifications do not support configuring different DMRS patterns within different RBs of a single transmission grant—assuming the RBs are within the same BWP. For example, it is not possible to configure DMRS only on symbol 2 in one RB and on both symbols 2 and 10 in another RB within the same scheduled DL/UL grant. Note that DMRS pattern variation is not limited to symbol count—it can include changes in frequency density, RE mapping, scrambling ID, number of DMRS ports, and other parameters.

Moreover, assuming the presence of AI-based channel estimation, the receiver can tolerate sparse DMRS patterns and even pilot-free RBs (i.e., where DMRS is omitted). This motivates the need to support different DMRS patterns across RBs. While using multiple BWPs with different DMRS assignments could theoretically enable different DMRS patterns across RBs, configuring multiple BWPs introduces unnecessary complexity and lacks flexibility.

According to 3GPP technical specification (TS) 38.213, the DMRS configuration is to be applied per BWP, and the same DMRS pattern is assumed across all RBs within a scheduled transmission in that BWP. The same DMRS pattern is assumed across all RBs within a scheduled transmission in that BWP if the transmission is scheduled though a DCI grant. The 3GPP specification does not support configuring different DMRS patterns for different RBs within the same BWP. This limitation restricts the flexibility of pilot placement, even in scenarios where AI-based receivers could tolerate or benefit from per-RB variation. Therefore, enabling per-RB DMRS configuration would require extensions beyond the current 3GPP framework.

Here we propose a framework to support per-RB DMRS pattern variation within a single transmission grant, enabling selective omission and reuse of DMRS REs for data. The signaling methods to enable this flexibility are discussed in the following.

In this disclosure, it is assumed that a UE 104 is scheduled to communicate (i.e., transmit or receive) within a transmission grant comprising one or more RBs over one or more time slots. While the often described in the context of uplink transmissions, the below solutions also generally apply to downlink transmissions, except where noted otherwise.

According to aspects of a first solution, the NE 102 may configure a UE 104 with a DMRS pattern for multiple RBs (e.g., the pattern spanning multiple RBs), with variations in the DMRS parameters between each RB of the DMRS pattern.

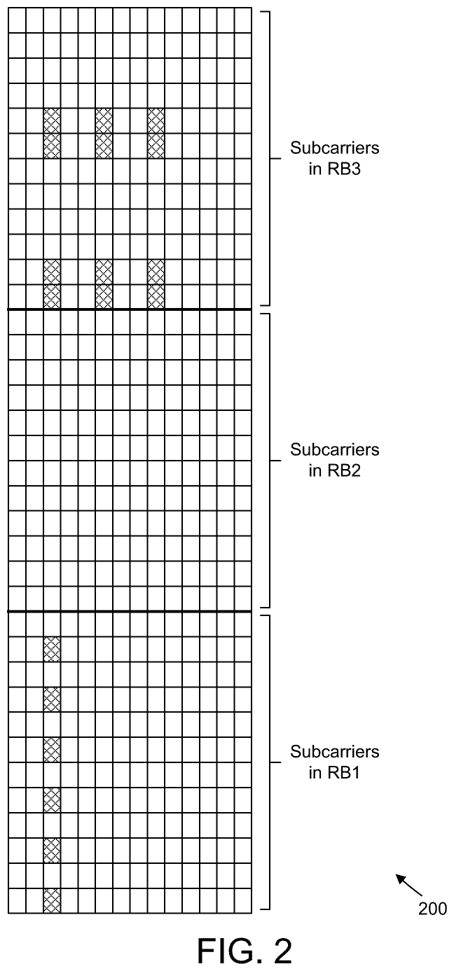

FIG. 2 illustrates an example of a DMRS pattern 200 for multiple RBs in the frequency domain, in accordance with aspects of the present disclosure. The DMRS pattern 200 may implement or be implemented by aspects of the wireless communication system 100. For example, the DMRS pattern 200 may be implemented by an NE 102 and a UE 104 as described herein. More specifically, the NE 102 may transmit a DMRS configuration to the UE 104, where the DMRS configuration indicates the DMRS pattern 200. The NE 102 and UE 104 may then communicate data (e.g., uplink data on the PUSCH or downlink data on the PDSCH) using the indicated DMRS pattern 200.

In the example of FIG. 2, the DMRS pattern 200 spans three RBs and specifies DMRS locations in each RB. The DMRS are present in the shaded REs, while the non-shaded REs are used to communicate data. In the depicted embodiment, DMRS are located on every second subcarrier in the first RB (denoted “RB1”) and during the third OFDM symbol (i.e. OFDM symbol 2); no DMRS are present in the second RB (denoted “RB2”); and DMRS are located in every third pair of subcarriers in the third RB (denoted “RB3”) and during the third, sixth, and ninth OFDM symbols (i.e. OFDM symbols 2, 5, and 8, respectively). To indicate the DMRS locations in the RB1, the NE 102 may indicate a DMRS configuration type 1, with no additional DMRS positions. To indicate the DMRS locations in the RB3, the NE 102 may indicate a DMRS configuration type 2, with two additional DMRS positions.

In some implementations, a set of candidate DMRS configurations for multiple RBs/time-slots may be pre-defined, e.g., set by specification and/or preloaded in the firmware or SIM of the UE 104. For example, the wireless specification may define a few different possibilities for DMRS configurations that span multiple RBs/time-slots, where each configuration shows which REs are associated/reserved for DMRS for k consecutive RBs (for example, k=3). The NE 102, then selects one of the specified DMRS configurations for the k consecutive RBs and transmits an indication of the selected DMRS configuration to the associated UE 104. For example, for a 3-RB pattern, the wireless specification may pre-define two patterns P1 and P2, where P1 represents RB1 with 1 DMRS symbol, RB2 with no DMRS, and RB3 with 3 DMRS symbols (e.g., similar DMRS symbol locations as shown in FIG. 2) and where P2 represents RB1 with 1 DMRS symbol, RB2 with 2 DMRS, and RB3 with 3 DMRS symbols. Thus, when the NE 102 indicates the DMRS configuration P1 to the UE 104, the UE 104 knows how it should assign the REs for DMRS transmission.

In certain implementations, the UE 104 may repeat a configured DMRS pattern and/or apply a portion of the configured DMRS pattern when the associated grant is a different size than the DMRS pattern. For example, if the UE 104 is scheduled with a number of RBs, m, that is greater than k (i.e., m>k), then the UE 104 may repeat the k-RB pattern cyclically. Applying the above example, for the 3-RB pattern and an allocation of 5 RBs, the UE 104 may apply RB1 with 1 DMRS symbol, RB2 with no DMRS, and RB3 with 3 DMRS symbols, and then repeat 3-RB pattern to the remainder of the allocated RBs, thus applying RB4 with 1 DMRS symbol and RB5 with no DMRS. Conversely, if the number of scheduled RBs, l, that is less than k (i.e., l<k), then the UE may apply the pattern to the first l RBs. Applying the above example, for the 3-RB pattern and an allocation of 2 RBs, the UE 104 may apply RB1 with 1 DMRS symbol and RB2 with no DMRS. In this scheme the specification contains all possible selections for different RB sizes.

In some other implementations, the set of candidate DMRS configurations for multiple RBs/time-slots are not pre-defined, e.g., are not preloaded in the firmware or SIM of the UE 104. For example, the wireless specification may not predefine the different possibilities for DMRS configurations for multiple RBs/time-slots. Instead, in certain implementations, the specification only defines different DMRS configurations per RB of one time slot as the building blocks, and for construction of the multi-RB/multi-time-slot assignment, the NE 102 uses the definition of per-RB DMRS configuration to configure the UE 104 how it should associated/reserved for DMRS for k consecutive RBs. In certain implementations, the DMRS configuration may explicitly indicate the number of consecutive RBs that the UE 104 should assume for DMRS configuration. Alternatively, the UE 104 may infer the number of RBs from the DMRS configuration. For example, the UE 104 may infer (e.g., determine) the number of consecutive RBs, e.g., k, for the DMRS pattern from a list of DMRS parameters for each RB in the DMRS pattern. As another example, the NE 102 may indicate modifications to a default or base DMRS configuration to configure the DMRS pattern for use.

In some implementations, a set of candidate DMRS configurations per RB of one time slot may be pre-defined, e.g., set by specification and/or preloaded in the firmware or SIM of the UE 104. For example, the wireless specification may define different DMRS configurations for a single-RB/single-time-slot. Accordingly, the NE 102 may configure the UE 104 with a list of DMRS parameter sets, where each item of the list contains a set of DMRS parameters represented by one of the DMRS patterns pre-defined for a single RB/time-slot and where at least some DMRS parameters are changing between at least two of the adjacent RBs/time-slots. For example, each set of DMRS parameters in the list may include a value for the DMRS configuration type (i.e., dmrs-type), the number of symbols per DMRS (i.e., MaxLength), additional DMRS positions (i.e., dmrs-AdditionalPosition), and on which ports DMRS should be transmitted at that RB. In certain implementations, the UE 104 may assume that any DMRS parameters that are not defined on a per-RB basis are to be the same for all RBs of the pattern. In certain implementations, the UE 104 may infer any DMRS parameters that are not explicitly defined the list (i.e., values for these DMRS parameters may be implicitly signaled by the NE 102).

In some implementations, the NE 102 may configure the UE 104 with a DMRS configuration containing base configuration that defines a full set of DMRS parameters for one RB, and the NE 102 may further transmit a list of modifications to the base configuration, thereby defining what is different in each RB of the DMRS pattern. In one implementation, the NE 102 may send the list of modifications separate from the base configuration. In another implementation, the NE 102 may send a DMRS configuration containing both the base configuration and the list of modifications. In certain implementations, the base configuration may be pre-configured (e.g., transmitted in RRC signaling or pre-stored in the UE 104) and the NE 102 may dynamically signal (e.g., in DCI or in CG configuration signaling) the list of differences (i.e., modifications) to be applied for each RB of the DMRS pattern to be used for the UL/DL transmission grant.

In some implementations, the NE 102 may configure the UE 104 with a DMRS configuration that defines a full set of DMRS parameters for a first RB of the DMRS pattern (i.e., the first RB of the transmission grant), and the NE 102 may further transmit a list of modifications to the first configuration, thereby defining what is different in each remaining RB of the DMRS pattern. In other words, the NE 102 may define a base configuration, which the UE 104 applies to the first RB of the DMRS, and a list of what should be modified in different RBs of the DMRS pattern.

In some implementations, the NE 102 may configure a DMRS pattern wherein one or more RBs of the pattern contain no DMRS at all (i.e., DMRS is omitted for these RBs). In certain implementations, a ‘no DMRS’ configuration may be defined as one of the possible pre-defined DMRS configurations (e.g., defined in the wireless specification). When DMRS is omitted in certain RBs, the NE 102 and/or UE 104 may reassign the corresponding REs for data transmission, thereby improving spectral efficiency.

In some implementations, the NE 102 and/or UE 104 may transmit DMRS for some ports on some RBs of the DMRS pattern, and may transmit DMRS for some other ports on some other RBs of the DMRS pattern. In certain implementations, the pre-defined base DMRS configurations may include parameters indicating how many ports should be transmitted on that RB and additionally include parameters indicating which ports should be transmitted on which DMRS symbols. For example, in cases of configuration for a 2-RB DMRS pattern and transmission of 4 DMRS ports, the NE 102 may configurate the UE 104 such that instead of 4 DMRS on all RBs, the first RB of the DMRS pattern may only include DMRS for ports 1 and 2, and the second RB of the DMRS pattern may only include DMRS for ports 3 and 4.

While the DMRS configuration transmitted by the NE 102 may be for k RBs, the UE 104 may apply the DMRS configuration to a transmission grant for a lesser number of scheduled RBs, e.g., l RBs, by starting from the configuration for first RB in the full DMRS configuration and sequentially apply the next set of DMRS parameters up to the l^{th} RBs. Similarly, the DMRS configuration may also be used for situations where the number of scheduled RBs is larger than k. One scheme could be to repeat the pattern of the k RBs until it covers all the scheduled RBs that are assigned for transmission grant.

According to aspects of a second solution, the NE 102 may configure a UE 104 with a DMRS pattern for multiple time slots (e.g., the pattern spanning multiple time slots), with variations in the DMRS parameters between each time slot of the DMRS pattern. For example, the DMRS pattern in the first time slot may include 1 DMRS symbols per RB and the second time slot may include 2 DMRS symbols per RB. Other variations may be in the third or subsequent time slots of the DMRS pattern.

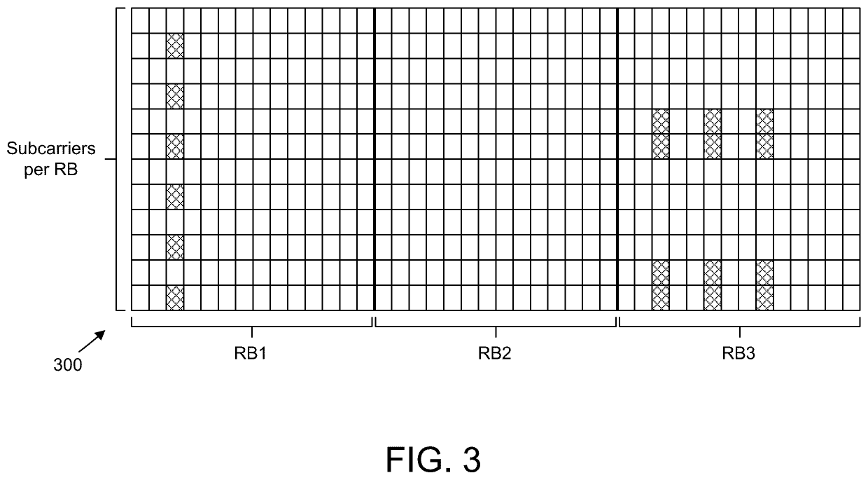

FIG. 3 illustrates an example of a DMRS pattern 300 for multiple slots in the time domain, in accordance with aspects of the present disclosure. The DMRS pattern 300 may implement or be implemented by aspects of the wireless communication system 100. For example, the DMRS pattern 300 may be implemented by an NE 102 and a UE 104 as described herein. More specifically, the NE 102 may transmit a DMRS configuration to the UE 104, where the DMRS configuration indicates the DMRS pattern 300. The NE 102 and UE 104 may then communicate data (e.g., uplink data on the PUSCH or downlink data on the PDSCH) using the indicated DMRS pattern 300.

In the example of FIG. 3, the DMRS pattern 300 spans three time slots and specifies DMRS locations in each RB. The DMRS are present in the shaded REs, while the non-shaded REs are used to communicate data. In the depicted embodiment, DMRS are located on every second subcarrier in the RB of the first time slot (denoted “RB1”) and during the third OFDM symbol (i.e. OFDM symbol 2); no DMRS are present in the RB of the second time slot (denoted “RB2”); and DMRS are located in every third pair of subcarriers in the RB of the third time slot (denoted “RB3”) and during the third, sixth, and ninth OFDM symbols (i.e. OFDM symbols 2, 5, and 8, respectively).

In some implementations, a set of candidate DMRS configurations for DMRS patterns spanning multiple time slots may be pre-defined, e.g., set by specification and/or preloaded in the firmware or SIM of the UE 104. The NE 102 may select one of the specified DMRS configurations for the k consecutive RBs and transmit an indication of the selected DMRS configuration to the associated UE 104. For example, for a 3-time-slot pattern, the wireless specification may pre-define two patterns P1 and P2, where P1 represents Slot1 with 1 DMRS symbol, Slot2 with no DMRS, and Slot3 with 3 DMRS symbols (e.g., similar DMRS symbol locations as shown in FIG. 3) and where P2 represents Slot1 with 1 DMRS symbol, Slot2 with 2 DMRS, and Slot3 with 3 DMRS symbols. Thus, when the NE 102 indicates the DMRS configuration P1 to the UE 104, the UE 104 knows how it should assign the REs for DMRS transmission.

In some other implementations, only a set of candidate DMRS configurations for a single RB of one time slot may be pre-defined, where the NE 102. g., are not preloaded in the firmware or SIM of the UE 104. Accordingly, the NE 102 may configure the UE 104 with a list of DMRS parameter sets, where each item of the list contains a set of DMRS parameters represented by one of the DMRS patterns pre-defined for a single RB/time-slot and where at least some DMRS parameters are changing between at least two of the adjacent time slots.

In some implementations, the DMRS configuration transmitted by the NE 102 does not specify the exact combination of parameters for the DMRS pattern in different time slots. In certain implementations, the DMRS configuration may explicitly indicate a subset of the DMRS parameters for the DMRS pattern, wherein the UE 104 then infers the remainder of the DMRS parameters. For example, the UE 104 may infer (e.g., determine) the number of consecutive time slots, e.g., k, for the DMRS pattern from a list of DMRS parameters for each time slot in the DMRS pattern. Alternatively, the DMRS configuration may explicitly configure the number of consecutive time slots for the DMRS pattern. As another example, the NE 102 may indicate modifications to a default or base DMRS configuration to configure the DMRS pattern for use.

In some implementations, the NE 102 may configure the UE 104 with a list of DMRS parameter sets, where each item of the list contains a set of DMRS parameters for a particular time slot of the DMRS pattern. For example, each set of DMRS parameters in the list may include a value for the DMRS configuration type (i.e., dmrs-type), the number of symbols per DMRS (i.e., MaxLength), additional DMRS positions (i.e., dmrs-AdditionalPosition), and on which ports DMRS should be transmitted at that time slot. In certain implementations, the UE 104 may assume that any DMRS parameters that are not defined on a per-time slot basis are to be the same for all time slots of the pattern. In certain implementations, the UE 104 may infer any DMRS parameters that are not explicitly defined the list (i.e., values for these DMRS parameters may be implicitly signaled by the NE 102).

In some implementations, the NE 102 may configure the UE 104 with a DMRS configuration containing base configuration that defines a full set of DMRS parameters for one time slot, and the NE 102 may further transmit a list of modifications to the base configuration, thereby defining what is different in each time slot of the DMRS pattern. In one implementation, the NE 102 may send the list of modifications separate from the base configuration. In another implementation, the NE 102 may send a DMRS configuration containing both the base configuration and the list of modifications. In certain implementations, the base configuration may be pre-configured (e.g., transmitted in RRC signaling or pre-stored in the UE 104) and the NE 102 may dynamically signal (e.g., in DCI or in CG configuration signaling) the list of differences (i.e., modifications) to be applied for each time slot of the DMRS pattern to be used for the UL/DL transmission grant.

In some implementations, the NE 102 may configure the UE 104 with a DMRS configuration that defines a full set of DMRS parameters for a first time slot of the DMRS pattern (i.e., the first time slot of the transmission grant), and the NE 102 may further transmit a list of modifications to the first configuration, thereby defining what is different in each remaining time slot of the DMRS pattern. In other words, the NE 102 may define a base configuration, which the UE 104 applies to the first time slot of the DMRS, and a list of what should be modified in different time slots of the DMRS pattern.

In some implementations, the NE 102 may configure a DMRS pattern wherein one or more time slots of the pattern contain no DMRS at all (i.e., DMRS is omitted for these time slots). In certain implementations, a ‘no DMRS’ configuration may be defined as one of the possible pre-defined DMRS configurations. When DMRS is omitted in certain time slots, the NE 102 and/or UE 104 may reassign the corresponding REs for data transmission, thereby improving spectral efficiency.

In some implementations, the NE 102 and/or UE 104 may transmit DMRS for some ports on some time slots of the DMRS pattern, and may transmit DMRS for some other ports on some other time slots of the DMRS pattern. In certain implementations, the pre-defined base DMRS configurations may include parameters indicating how many ports should be transmitted on the RB per time slot, and additionally include parameters indicating which ports should be transmitted on which DMRS symbols. For example, in cases of configuration for a 2-time slot DMRS pattern and transmission of 4 DMRS ports, the first time slot of the DMRS pattern may only include DMRS for ports 1 and 2, and the second time slot of the DMRS pattern may only include DMRS for ports 3 and 4.

While the DMRS configuration transmitted by the NE 102 may be for k time slots, the UE 104 may apply the DMRS configuration to a transmission grant for a lesser number of scheduled time slots, e.g., l time slots, by starting from the configuration for first time slot in the full DMRS configuration and sequentially apply the next set of DMRS parameters up to the l^{th} time slots. Similarly, the DMRS configuration may also be used for situations where the number of scheduled time slots is larger than k. One scheme could be to repeat the pattern of the k time slots until it covers all the scheduled time slots that are assigned for transmission grant.

According to aspects of a third solution, the NE 102 may configure a UE 104 with a DMRS pattern for multiple RBs and multiple time slots (e.g., the pattern spanning both multiple RBs and multiple time slots), with variations in the DMRS parameters between different RBs and time slots of the DMRS pattern. In other words, the DMRS configurations described above for a DMRS pattern for multiple RBs and the DMRS configurations described above for a DMRS pattern for multiple time slots may be combined. In certain implementations, the DMRS configuration may include an indication of whether a set of DMRS parameters is for a next RB in the DMRS pattern or a next time slot in the DMRS pattern.

In some implementations, a set of candidate DMRS configurations for DMRS patterns spanning multiple RBs and multiple time slots may be pre-defined, e.g., set by specification and/or preloaded in the firmware or SIM of the UE 104. The NE 102 may select one of the pre-defined DMRS configurations and transmit an indication of the selected DMRS configuration to the associated UE 104. In some other implementations, only a set of candidate DMRS configurations for a single RB of one time slot may be pre-defined, where the NE 102. g., are not preloaded in the firmware or SIM of the UE 104. Accordingly, the NE 102 may configure the UE 104 with a list of DMRS parameter sets, where each item of the list contains a set of DMRS parameters represented by one of the DMRS patterns pre-defined for a single-RB/single-time-slot and where at least some DMRS parameters are changing between at least two of the adjacent time slots.

In some implementations, the DMRS configuration transmitted by the NE 102 may show which REs are associated/reserved for DMRS for j consecutive RBs (for example, j=3) and k consecutive time slots (for example, k=2). For example, a 3×2 DMRS pattern may define: RB1 of slot1 with 1 DMRS symbol, RB2 of slot1 with no DMRS, and RB3 of slot1 with 3 DMRS symbols, RB1 of slot2 with 4 DMRS symbol, RB2 of slot2 with 1 DMRS symbol, and RB3 of slot2 with 2 DMRS symbols.

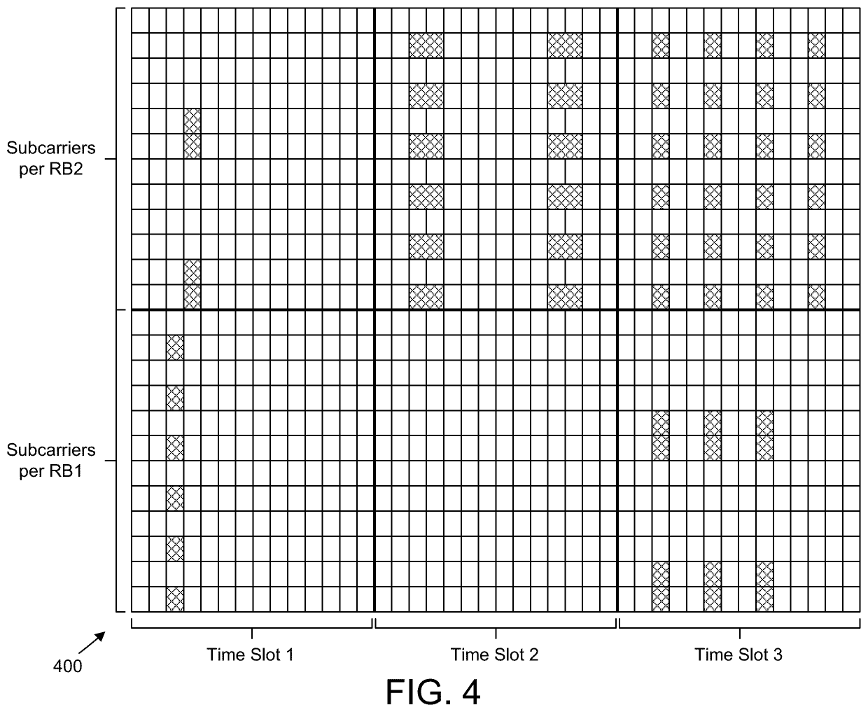

FIG. 4 illustrates an example of a DMRS pattern 400 for multiple RBs and multiple time slots, in accordance with aspects of the present disclosure. The DMRS pattern 400 may implement or be implemented by aspects of the wireless communication system 100. For example, the DMRS pattern 400 may be implemented by an NE 102 and a UE 104 as described herein. More specifically, the NE 102 may transmit a DMRS configuration to the UE 104, where the DMRS configuration indicates the DMRS pattern 400. The NE 102 and UE 104 may then communicate data (e.g., uplink data on the PUSCH or downlink data on the PDSCH) using the indicated DMRS pattern 400.

In the example of FIG. 4, the DMRS pattern 400 is a 2×3 pattern that spans two RBs and three time slots (i.e., j=2, k=3), and specifies DMRS locations in each RB per time slot. The DMRS are present in the shaded REs, while the non-shaded REs are used to communicate data. In the depicted embodiment, DMRS are located on every second subcarrier in the first RB (denoted “RB1”) of the first time slot (denoted “Time Slot 1”) and during the third OFDM symbol (i.e. OFDM symbol 2); no DMRS are present in RB1 of the second time slot (denoted “Time Slot 2”); and DMRS are located in every third pair of subcarriers in RB1 of the third time slot (denoted “Time Slot 3”) and during the third, sixth, and ninth OFDM symbols (i.e. OFDM symbols 2, 5, and 8, respectively). DMRS are also located on every third pair of subcarriers in the second RB (denoted “RB2”) of Time Slot 1 during the fourth OFDM symbol (i.e. OFDM symbol 3); two double-symbol DMRS located on every second subcarrier in RB2 of Time Slot 2 during the third and fourth OFDM symbols and again during the eleventh and twelfth OFDM symbols (i.e. spanning OFDM symbols 2-3 and 10-11, respectively); and four DMRS are located in every second subcarrier in RB2 of Time Slot 3 during the third and sixth, ninth, and twelfth OFDM symbols (i.e. OFDM symbols 2, 5, 8, and 11, respectively).

In some implementations, the NE 102 may transmit a DMRS configuration comprising a first superset of DMRS parameters for all RBs in a first time slot, a second superset of DMRS parameters for all RBs in a second time slot, etc. In some examples, the DMRS configuration may include a marker (or flag) separating the one superset from the subsequent superset, thereby indicating that the next configurations (following the marker) are for the next time slot in the DMRS pattern. Alternatively, the DMRS configuration may list the DMRS parameter sets of the time slots in the DMRS pattern, and then send a marker showing that the next configurations are for the next RB in the DMRS pattern, and then send the DMRS parameter sets that should be used for the time slots of the next RB.

In some implementations, the NE 102 may configure the UE 104 with a list of DMRS parameter sets, where each item of the list contains a set of DMRS parameters for a particular RB and time slot of the DMRS pattern. In certain implementations, the UE 104 may infer any DMRS parameters that are not explicitly defined in the list.

In some implementations, the NE 102 may configure the UE 104 with a DMRS configuration containing base configuration that defines a full set of DMRS parameters for one RB, and the NE 102 may further transmit a list of per-RB variations and/or per-slot variations to the base configuration, thereby defining what is different in each RB and/or time slot of the DMRS pattern.

In some implementations, the NE 102 may configure the UE 104 with a DMRS configuration that defines a full set of DMRS parameters for a first RB of the DMRS pattern (i.e., the first RB of the transmission grant), and the NE 102 may further transmit a list of per-RB variations and/or per-slot variations to the first configuration, thereby defining what is different in each remaining RB of the DMRS pattern.

In some implementations, the variations may be between different RB groups instead of between each RB. For example, the first 4-RB group may have a certain DMRS pattern and then next 4-RB group has another DMRS pattern. Similarly, the variations may be defined between different time slot groups instead of between each time slot. Beneficially, defining variations between different RB groups and/or different time slot groups reduces the number of variations that need to be communicated between NE 102 and UE 104, thereby reducing signaling overhead.

In some implementations, configure a DMRS pattern wherein one or more RBs of the pattern contain no DMRS at all (i.e., DMRS is omitted for these RBs), especially in scenarios where AI-based receivers can maintain performance with sparse pilot signal density. In certain implementations, the NE 102 and/or UE 104 may implement selective reuse of resource elements (REs) that would otherwise be reserved for DMRS. For example, when a DMRS is omitted in certain RBs, the NE 102 and/or UE 104 may reassign the corresponding REs for data transmission, thereby improving spectral efficiency.

While the DMRS configuration transmitted by the NE 102 may be for k RBs, the UE 104 may apply the DMRS configuration to a transmission grant for a lesser number of scheduled RBs, e.g., l RBs, by starting from the configuration for first RB in the full DMRS configuration and sequentially apply the next set of DMRS parameters up to the l^{th} RBs. Similarly, the DMRS configuration may also be used for situations where the number of scheduled RBs is larger than k. One scheme could be to repeat the pattern of the k RBs until it covers all the scheduled RBs that are assigned for transmission grant.

Additionally, in some implementations, the DMRS configuration may define DMRS patterns for a fixed number of RBs or time slots (e.g., j RBs and k time slots), and the UE 104 may apply fallback behavior when the actual number of scheduled RBs or time slots differs from the fixed number. For example, if the UE 104 is scheduled with fewer than j RBs and/or fewer than k time slots, then the UE 104 applies the defined DMRS pattern to the first l RBs or m time slots (where l<j and m<k). Conversely, if the UE 104 is scheduled with more than j RBs and/or more than k time slots, then the UE 104 may repeat the DMRS pattern cyclically. This flexible reuse and fallback mechanism ensures compatibility with varying transmission sizes while maintaining the benefits of reduced DMRS overhead.

According to aspects of a third solution, to support flexible DMRS configurations across multiple resource blocks (RBs) and/or time slots, the NE 102 and/or UE 104 may implement signaling mechanisms that extend existing RRC and/or DCI frameworks. These signaling mechanisms enable the NE 102 to convey per-RB and per-slot DMRS variation to one or more UEs 104, e.g., in a compact and scalable manner.

In some implementations, the NE 102 may deliver the DMRS configuration via higher-layer signaling (e.g., RRCReconfiguration), where the DMRS configuration includes a list of DMRS parameter sets, and each item in the list corresponds to a specific RB or time slot In certain implementations, this DMRS configuration may contains fields such as: the DMRS type (Type 1 or Type 2), the number of symbols per DMRS, additional DMRS positions, scrambling ID, port allocation and which ports should be transmitted on each RB, e.g., as described above.

In certain implementations, each item in the list may be tagged with an identifier indicating whether it applies to an RB or a time slot. In certain implementations, a marker or flag may be used to signal transitions between RB-level and slot-level configuration. In some other implementations, each RB and time slot in the DMRS pattern may be associated with an index and each item the list may be correlated with an index of the DMRS pattern. For example, a first item in the list may correspond to a first RB in a first time slot of the DMRS pattern, a second item in the list may correspond to a second RB in the first time slot (alternatively a first RB of a second time slot) of the DMRS pattern, and so forth.

In some other implementations, the NE 102 may encode the DMRS configuration using a base DMRS configuration applicable to all RBs or slots, along with a set of differences (e.g., delta values) that specify modifications for selected RBs or slots. Beneficially, this approach reduces signaling overhead by avoiding repetition of common parameters.

In some implementations, the DMRS configuration may define a cyclic DMRS pattern for a fixed number of RBs or slots. When the number of scheduled RBs or slots exceeds the configured pattern length, then the UE 104 repeats the pattern cyclically. If the NE 102 schedules fewer RBs or slots then defined in the DMRS configuration, then the UE 104 applies the pattern to the first l RBs or slots.

In some implementations, the DMRS configuration (or dynamic signaling) may also include a flag indicating whether DMRS are omitted in certain RBs and/or whether the REs corresponding to omitted DMRS are to be reused for data communication. Beneficially, this enables dynamic optimization of spectral efficiency based on the receiver's capabilities.

In some implementations, before the NE 102 configures a UE 104 with such DMRS configuration having different DMRS patterns for different RBs and/or time slots, the UE 104 may first indicate to the NE 102 that it supports (i.e., is capable of handling) different DMRS patterns for different RBs and/or time slots.

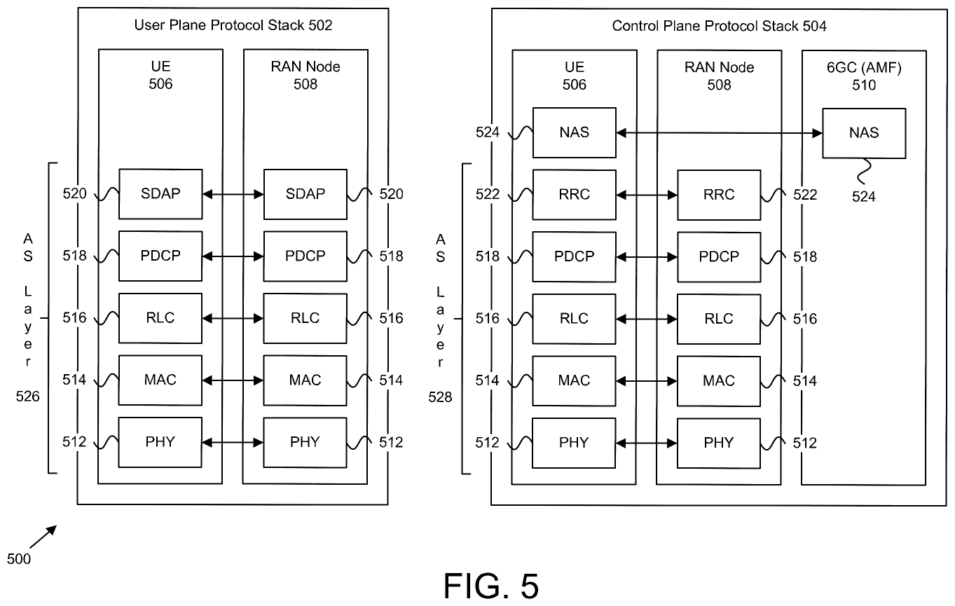

FIG. 5 illustrates an example of a protocol stack 500, in accordance with aspects of the present disclosure. While FIG. 5 shows a UE 506, a RAN node 508, and a 5GC 510 (e.g., including at least an AMF), these are representative of a set of UEs 104 interacting with an NE 102 (e.g., base station) and a CN 106. As depicted, the protocol stack 500 includes a user plane protocol stack 502 and a control plane protocol stack 504. The user plane protocol stack 502 includes a physical (PHY) layer 512, a MAC sublayer 514, a radio link control (RLC) sublayer 516, a packet data convergence protocol (PDCP) sublayer 518, and a service data adaptation protocol (SDAP) sublayer 520. The control plane protocol stack 504 includes a PHY layer 512, a MAC sublayer 514, an RLC sublayer 516, and a PDCP sublayer 518. The control plane protocol stack 504 also includes a RRC layer 522 and a non-access stratum (NAS) layer 524.

The AS layer 526 (also referred to as “AS protocol stack”) for the user plane protocol stack 502 consists of at least the SDAP sublayer 520, the PDCP sublayer 518, the RLC sublayer 516, the MAC sublayer 514, and the PHY layer 512. The AS layer 528 for the control plane protocol stack 504 consists of at least the RRC layer 522, the PDCP sublayer 518, the RLC sublayer 516, the MAC sublayer 514, and the PHY layer 512. The layer-1 (L1) includes the PHY layer 512. The layer-2 (L2) is split into the SDAP sublayer 520, PDCP sublayer 518, RLC sublayer 516, and MAC sublayer 514. The layer-3 (L3) includes the RRC layer 522 and the NAS layer 524 for the control plane and includes, e.g., an internet protocol (IP) layer and/or PDU layer (not depicted) for the user plane. L1 and L2 are referred to as “lower layers,” while L3 and above (e.g., transport layer, application layer) are referred to as “higher layers” or “upper layers.”

The PHY layer 512 offers transport channels to the MAC sublayer 514. The PHY layer 512 may perform a beam failure detection procedure using energy detection thresholds, as described herein. In certain implementations, the PHY layer 512 may send an indication of beam failure to a MAC entity at the MAC sublayer 514. The MAC sublayer 514 offers logical channels (LCHs) to the RLC sublayer 516. The RLC sublayer 516 offers RLC channels to the PDCP sublayer 518.

The PDCP sublayer 518 offers radio bearers to the SDAP sublayer 520 and/or RRC layer 522. The SDAP sublayer 520 offers QoS flows to the core network (e.g., 5GC). The RRC layer 522 provides for the addition, modification, and release of carrier aggregation (CA) and/or dual connectivity, such as E-UTRAN-NR Dual Connectivity (EN-DC) for 4G/5G dual connectivity. The RRC layer 522 also manages the establishment, configuration, maintenance, and release of signaling radio bearers (SRBs) and data radio bearers (DRBs).

The NAS layer 524 is between the UE 506 and an AMF in the 5GC 510. NAS messages are passed transparently through the RAN. The NAS layer 524 is used to manage the establishment of communication sessions and for maintaining continuous communication with the UE 506 as it moves between different cells of the RAN. In contrast, the AS layers 526 and 528 are between the UE 506 and the RAN (i.e., RAN node 508) and carry information over the wireless portion of the network. While not depicted in FIG. 5, the IP layer exists above the NAS layer 524, a transport layer exists above the IP layer, and an application layer exists above the transport layer.

The MAC sublayer 514 is the lowest sublayer in the L2 architecture of the NR protocol stack. Its connection to the PHY layer 512 below is through transport channels, and the connection to the RLC sublayer 516 above is through LCHs. The MAC sublayer 514 therefore performs multiplexing and demultiplexing between LCHs and transport channels: the MAC sublayer 514 in the transmitting side constructs MAC PDUs (also known as TBs) from MAC service data units (SDUs) received through LCHs, and the MAC sublayer 514 in the receiving side recovers MAC SDUs from MAC PDUs received through transport channels.

The MAC sublayer 514 provides a data transfer service for the RLC sublayer 516 through LCHs, which are either control LCHs which carry control data (e.g., RRC signaling) or traffic LCHs which carry user plane data. On the other hand, the data from the MAC sublayer 514 is exchanged with the PHY layer 512 through transport channels, which are classified as UL or DL. Data is multiplexed into transport channels depending on how it is transmitted over the air.

The PHY layer 512 is responsible for the actual transmission of data and control information via the air interface, i.e., the PHY layer 512 carries all information from the MAC transport channels over the air interface on the transmission side. Some of the important functions performed by the PHY layer 512 include coding and modulation, link adaptation (e.g., adaptive modulation and coding (AMC)), power control, cell search and random access (for initial synchronization and handover purposes) and other measurements (inside the 3GPP system (i.e., NR and/or LTE system) and between systems) for the RRC layer 522. The PHY layer 512 performs transmissions based on transmission parameters, such as the modulation order, the coding rate (e.g., the modulation and coding scheme (MCS) which indicates both the modulation order and coding rate), the number of physical resource blocks (PRBs), etc.

In 5G NR, the resource block (RB) typically spans 12 subcarriers, and the bandwidth of the RB depends on the SCS used in the 5G NR system. For example, for 15 kHz SCS, the bandwidth of one RB is 180 kHz, while for 30 kHz SCS, the bandwidth of one RB is 360 kHz. Similarly, for 50 kHz SCS, the bandwidth of one RB is 720 kHz, while for 120 kHz SCS, the bandwidth of one RB is 1.44 MHz.

The duration of an RB in time is one slot, which may be composed of, e.g., 14 OFDM symbols in the time domain. In 5G NR, the time duration of an RB is based on the slot duration, which may vary according to the numerology and SCS used. For example, for 15 kHz SCS, the time duration of one RB (i.e., slot duration) is 1 msec, while for 30 kHz SCS, the time duration of one RB (slot duration) is 0.5 msec. Similarly, for 50 kHz SCS, the time duration of one RB (i.e., slot duration) is 0.25 msec, while for 120 kHz SCS, the time duration of one RB (slot duration) is 0.125 msec.

In some implementations, the protocol stack 500 may be an NR protocol stack used in a 5G NR system. An LTE protocol stack includes similar structure to the protocol stack 500, with the differences that the LTE protocol stack lacks the SDAP sublayer 520 in the AS layer 526, that an EPC replaces the 5GC 510, and that the NAS layer 524 is between the UE 506 and an MME in the EPC. Also, the present disclosure distinguishes between a protocol layer (such as the aforementioned PHY layer 512, MAC sublayer 514, RLC sublayer 516, PDCP sublayer 518, SDAP sublayer 520, RRC layer 522 and NAS layer 524) and a transmission layer in MIMO communication (also referred to as a “MIMO layer” or a “data stream”).

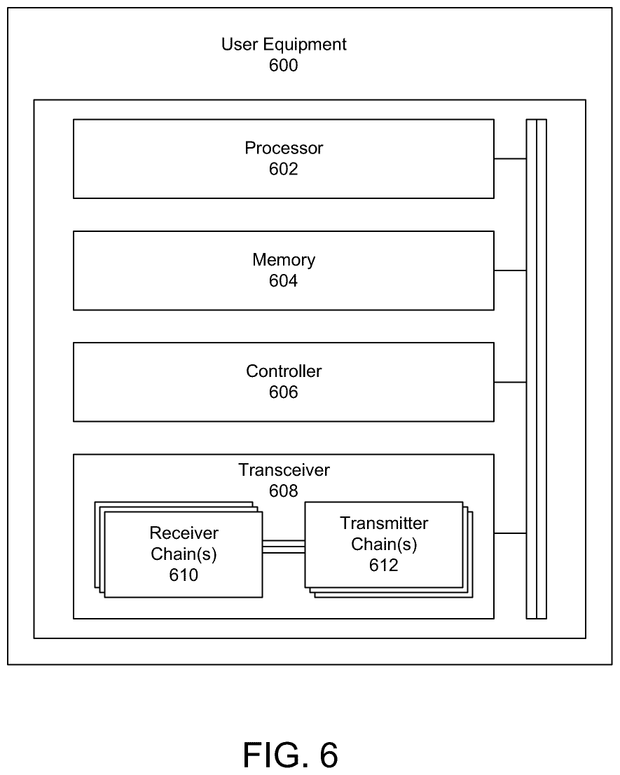

FIG. 6 illustrates an example of a UE 600 in accordance with aspects of the present disclosure. The UE 600 may include a processor 602, a memory 604, a controller 606, and a transceiver 608. The processor 602, the memory 604, the controller 606, or the transceiver 608, or various combinations thereof or various components thereof may be examples of means for performing various aspects of the present disclosure as described herein. These components may be coupled (e.g., operatively, communicatively, functionally, electronically, electrically) via one or more interfaces.

The processor 602, the memory 604, the controller 606, or the transceiver 608, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 602 may include an intelligent hardware device (e.g., a general-purpose processor, a DSP, a central processing unit (CPU), an ASIC, a field programmable gate array (FPGA), or any combination thereof). In some implementations, the processor 602 may be configured to operate the memory 604. In some other implementations, the memory 604 may be integrated into the processor 602. The processor 602 may be configured to execute computer-readable instructions stored in the memory 604 to cause the UE 600 to perform various functions of the present disclosure.

The memory 604 may include volatile or non-volatile memory. The memory 604 may store computer-readable, computer-executable code including instructions that, when executed by the processor 602, cause the UE 600 to perform various functions described herein. The code may be stored in a non-transitory computer-readable medium such the memory 604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 602 and the memory 604 coupled with the processor 602 may be configured to cause the UE 600 to perform various functions (e.g., operations, signaling) described herein (e.g., executing, by the processor 602, instructions stored in the memory 604). In some implementations, the processor 602 may include multiple processors and the memory 604 may include multiple memories. One or more of the multiple processors may be coupled with one or more of the multiple memories, which may be individually or collectively, configured to perform various functions (e.g., operations, signaling) of the UE 600 as described herein.

The processor 602 coupled with the memory 604 may be configured to, capable of, or operable to cause the UE 600 to receive, from a base station, a configuration indicating a DMRS pattern for a plurality of RBs or a plurality of time slots, or both, where the DMRS pattern comprises different DMRS parameters to be applied across the plurality of RBs or the plurality of time slots, or both; and communicate data with the base station (e.g., transmit and/or receive user data or control plane signaling different that an RS transmission) using a transmission grant in accordance with a set of DMRS parameters for each RB or time slot associated with a transmission grant. In some implementations, the processor 602 coupled with the memory 604 may be configured to, capable of, or operable to cause the UE 600 to determine the set of DMRS parameters for the transmission grant, e.g., based on the DMRS configuration.

In some implementations, the different DMRS parameters to be applied across the plurality of RBs or the plurality of time slots, or both, comprises one or more of: A) differing DMRS symbol positions for the plurality of RBs, B) differing DMRS symbol positions for the plurality of time slots, C) differing DMRS types for the plurality of RBs, D) differing DMRS types for the plurality of time slots, E) differing frequency-domain densities for the plurality of RBs, F) differing frequency-domain densities for the plurality of time slots, G) differing numbers of DMRS symbols for the plurality of RBs, H) differing numbers of DMRS symbols for the plurality of time slots, I) differing DMRS port allocations for the plurality of RBs, J) differing DMRS port allocations for the plurality of time slots, K) differing DMRS scrambling for the plurality of RBs for the plurality of time slots, L) differing DMRS scrambling for the plurality of RBs for the plurality of time slots, M) omission of DMRS in one or more RBs of the DMRS pattern, N) omission of DMRS in one or more time slots of the DMRS pattern, or a combination thereof.

In some implementations, the DMRS pattern is associated with a particular BWP, and the transmission grant is within the particular BWP. In such embodiments, the processor 602 coupled with the memory 604 may be configured to, capable of, or operable to cause the UE 600 to determine the set of DMRS parameters based on the particular BWP associated with the transmission grant.

In some implementations, the configuration indicates a single transmission grant comprising the plurality of RBs and the plurality of time slots, such that the DMRS pattern is associated with the single transmission grant. In such embodiments, the processor 802 coupled with the memory 804 may be configured to, capable of, or operable to cause the NE 800 to determine the set of DMRS parameters based on the received configuration associated with the single transmission grant.

In some implementations, the configuration comprises an indication (e.g., implicit or express) of a number of RBs or time slots in the configuration and a list of DMRS parameter sets. In such implementations, each DMRS parameter set in the list of DMRS parameter sets corresponds to a respective RB or time slot of the DMRS pattern. In certain implementations, the configuration comprises an identifier indicating whether a specific DMRS parameter applies to a next RB or a next time slot. In certain implementations, the configuration comprises an indication of a transition between an RB-level DMRS sub-configuration and a time slot-level DMRS sub-configuration.

In some implementations, the configuration comprises an indication of a number of RBs or time slots in the configuration, a base DMRS configuration, and a list of modifications applicable to each of the plurality of RBs or time slots of the DMRS pattern. In certain implementations, to determine the set of set of DMRS parameters, the processor 602 coupled with the memory 604 may be configured to, capable of, or operable to cause the UE 600 to apply the base DMRS configuration to a first RB in a first time slot associated with the transmission grant and apply the list of modifications to a remainder of the plurality of RBs or time slots of the DMRS pattern. In some implementations, the number of subcarriers in each RB the plurality of RBs is fixed or set by the configuration message.

In some implementations, the configuration defines a cyclic DMRS pattern across a fixed number of RBs or time slots, or both. In such implementations, the processor 602 coupled with the memory 604 may be configured to, capable of, or operable to cause the UE 600 to determine the set of DMRS parameters for each RB or time slot associated with the transmission grant by applying the cyclic DMRS pattern cyclically when the number of scheduled RBs or time slots associated with the transmission grant exceeds the fixed number.

In some implementations, the configuration defines the DMRS pattern across a fixed number of RBs or time slots, or both. In such implementations, the processor 602 coupled with the memory 604 may be configured to, capable of, or operable to cause the UE 600 to determine the set of DMRS parameters for each RB or time slot associated with the transmission grant by applying a portion the DMRS pattern when the number of scheduled RBs or time slots associated with the transmission grant is less than the fixed number.

In some implementations, the DMRS pattern indicates an omission of DMRS of at least some DMRS ports for at least one RB or at least one time slot, or both. In such implementations, the processor 602 coupled with the memory 604 may be configured to, capable of, or operable to cause the UE 600 to communicate the data using one or more resources reserved for DMRS in the at least one RB or at least one time slot where DMRS is omitted.

In some implementations, the UE 600 may further comprise an AI-based receiver configured to receive the data using the determined set of DMRS parameters and perform channel estimation using the determined set of DMRS parameters. For example, the processor 602 coupled with the memory 604 and the transceiver 608 may form the AI-based receiver that receives the data and performs the channel estimation using the determined set of DMRS parameters. In certain implementations, the AI-based receiver receives the data and performs the channel estimation even in cases where the DMRS is omitted in one or more RBs and/or one or more time slots, or where the DMRS patterns varies across RBs or time slots.

The controller 606 may manage input and output signals for the UE 600. The controller 606 may also manage peripherals not integrated into the UE 600. In some implementations, the controller 606 may utilize an operating system (OS) such as iOS®, ANDROID®, WINDOWS®, or other operating systems. In some implementations, the controller 606 may be implemented as part of the processor 602.

In some implementations, the UE 600 may include at least one transceiver 608. In some other implementations, the UE 600 may have more than one transceiver 608. The transceiver 608 may represent a wireless transceiver. The transceiver 608 may include one or more receiver chains 610, one or more transmitter chains 612, or a combination thereof.

A receiver chain 610 may be configured to receive signals (e.g., control information, data, packets) over a wireless medium. For example, the receiver chain 610 may include one or more antennas for receiving the signal over the air or wireless medium. The receiver chain 610 may include at least one amplifier (e.g., a low-noise amplifier (LNA)) configured to amplify the received signal. The receiver chain 610 may include at least one demodulator configured to demodulate the received signal and obtain the transmitted data by reversing the modulation technique applied during transmission of the signal. The receiver chain 610 may include at least one decoder for /coding/ processing the demodulated signal to receive the transmitted data.

A transmitter chain 612 may be configured to generate and transmit signals (e.g., control information, data, packets). The transmitter chain 612 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 612 may also include at least one power amplifier configured to amplify the modulated signal to an appropriate power level suitable for transmission over the wireless medium. The transmitter chain 612 may also include one or more antennas for transmitting the amplified signal into the air or wireless medium.

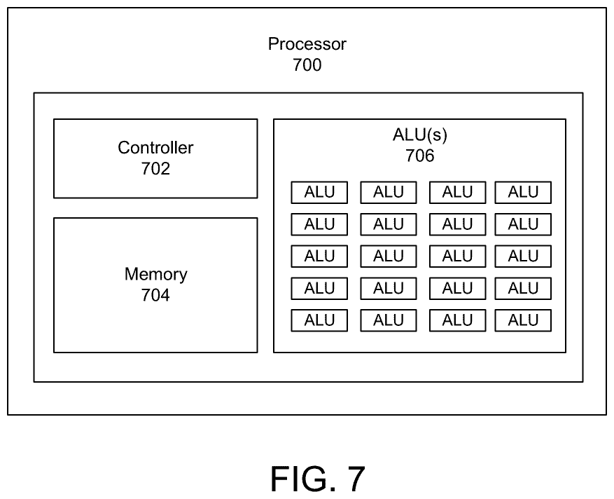

FIG. 7 illustrates an example of a processor 700 in accordance with aspects of the present disclosure. The processor 700 may be an example of a processor configured to perform various operations in accordance with examples as described herein. The processor 700 may include a controller 702 configured to perform various operations in accordance with examples as described herein. The processor 700 may optionally include at least one memory 704, which may be, for example, an L1, or L2, or L3 cache. Additionally, or alternatively, the processor 700 may optionally include one or more arithmetic-logic units (ALUs) 706. One or more of these components may be in electronic communication or otherwise coupled (e.g., operatively, communicatively, functionally, electronically, electrically) via one or more interfaces (e.g., buses).

The processor 700 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 700) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 702 may be configured to manage and coordinate various operations (e.g., signaling, receiving, obtaining, retrieving, transmitting, outputting, forwarding, storing, determining, identifying, accessing, writing, reading) of the processor 700 to cause the processor 700 to support various operations in accordance with examples as described herein. For example, the controller 702 may operate as a control unit of the processor 700, generating control signals that manage the operation of various components of the processor 700. These control signals include enabling or disabling functional units, selecting data paths, initiating memory access, and coordinating timing of operations.

The controller 702 may be configured to fetch (e.g., obtain, retrieve, receive) instructions from the memory 704 and determine subsequent instruction(s) to be executed to cause the processor 700 to support various operations in accordance with examples as described herein. The controller 702 may be configured to track memory address of instructions associated with the memory 704. The controller 702 may be configured to decode instructions to determine the operation to be performed and the operands involved. For example, the controller 702 may be configured to interpret the instruction and determine control signals to be output to other components of the processor 700 to cause the processor 700 to support various operations in accordance with examples as described herein. Additionally, or alternatively, the controller 702 may be configured to manage flow of data within the processor 700. The controller 702 may be configured to control transfer of data between registers, arithmetic logic units (ALUs), and other functional units of the processor 700.

The memory 704 may include one or more caches (e.g., memory local to or included in the processor 700 or other memory, such RAM, ROM, DRAM, SDRAM, SRAM, MRAM, flash memory, etc. In some implementations, the memory 704 may reside within or on a processor chipset (e.g., local to the processor 700). In some other implementations, the memory 704 may reside external to the processor chipset (e.g., remote to the processor 700).

The memory 704 may store computer-readable, computer-executable code including instructions that, when executed by the processor 700, cause the processor 700 to perform various functions described herein. The code may be stored in a non-transitory computer-readable medium such as system memory or another type of memory. The controller 702 and/or the processor 700 may be configured to execute computer-readable instructions stored in the memory 704 to cause the processor 700 to perform various functions. For example, the processor 700 and/or the controller 702 may be coupled with or to the memory 704, the processor 700, the controller 702, and the memory 704 may be configured to perform various functions described herein. In some examples, the processor 700 may include multiple processors and the memory 704 may include multiple memories. One or more of the multiple processors may be coupled with one or more of the multiple memories, which may, individually or collectively, be configured to perform various functions herein.

The one or more ALUs 706 may be configured to support various operations in accordance with examples as described herein. In some implementations, the one or more ALUs 706 may reside within or on a processor chipset (e.g., the processor 700). In some other implementations, the one or more ALUs 706 may reside external to the processor chipset (e.g., the processor 700). One or more ALUs 706 may perform one or more computations such as addition, subtraction, multiplication, and division on data. For example, one or more ALUs 706 may receive input operands and an operation code, which determines an operation to be executed. One or more ALUs 706 be configured with a variety of logical and arithmetic circuits, including adders, subtractors, shifters, and logic gates, to process and manipulate the data according to the operation. Additionally, or alternatively, the one or more ALUs 706 may support logical operations such as AND, OR, exclusive-OR (XOR), not-OR (NOR), and not-AND (NAND), enabling the one or more ALUs 706 to handle conditional operations, comparisons, and bitwise operations.

In some implementations, the processor 700 may support various functions (e.g., operations, signaling) of a UE, in accordance with examples as disclosed herein. For example, the controller 702 coupled with the memory 704 may be configured to, capable of, or operable to cause the processor 700 to receive, from a base station, a configuration indicating a DMRS pattern for a plurality of RBs or a plurality of time slots, or both, where the DMRS pattern comprises different DMRS parameters to be applied across the plurality of RBs or the plurality of time slots, or both; and communicate data with the base station (e.g., transmit and/or receive the data) using a transmission grant in accordance with a set of DMRS parameters for each RB or time slot associated with a transmission grant. Moreover, the controller 702 coupled with the memory 704 may be configured to, capable of, or operable to cause the processor 700 to perform one or more functions (e.g., operations, signaling) of the UE as described herein.

In certain implementations, the processor 700 may support various functions (e.g., operations, signaling) of a RAN node (e.g., base station or gNB), in accordance with examples as disclosed herein. For example, the controller 702 coupled with the memory 704 may be configured to, capable of, or operable to cause the processor 700 to transmit, to a UE, a configuration indicating a DMRS pattern for a plurality of RBs or a plurality of time slots, or both, wherein the DMRS pattern comprises different DMRS parameters to be applied across the plurality of RBs or the plurality of time slots, or both; and communicate data with the UE (e.g., transmit and/or receive the data) using a transmission grant in accordance with a set of DMRS parameters for each RB or time slot associated with a transmission grant. Moreover, the controller 702 coupled with the memory 704 may be configured to, capable of, or operable to cause the processor 700 to perform one or more functions (e.g., operations, signaling) of the RAN node as described herein.

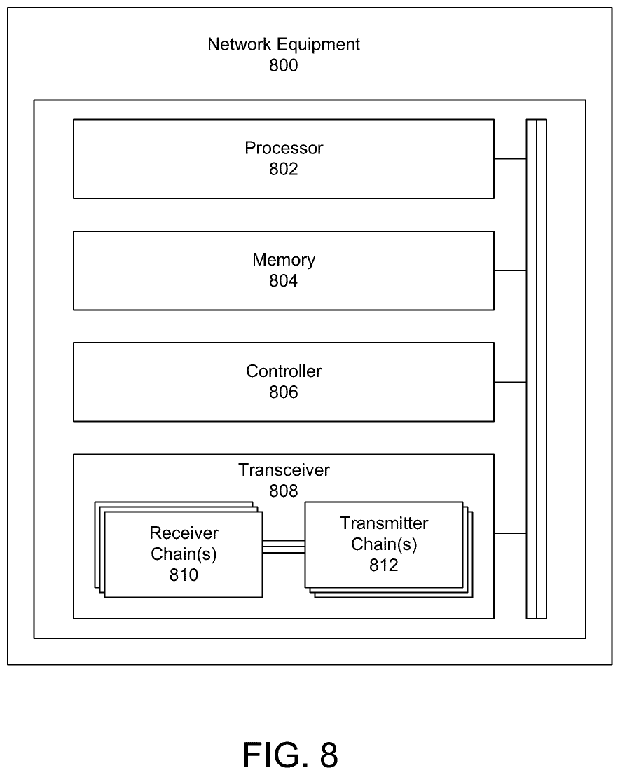

FIG. 8 illustrates an example of a NE 800 in accordance with aspects of the present disclosure. The NE 800 may include a processor 802, a memory 804, a controller 806, and a transceiver 808. The processor 802, the memory 804, the controller 806, or the transceiver 808, or various combinations thereof or various components thereof may be examples of means for performing various aspects of the present disclosure as described herein. These components may be coupled (e.g., operatively, communicatively, functionally, electronically, electrically) via one or more interfaces.

The processor 802, the memory 804, the controller 806, or the transceiver 808, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 802 may include an intelligent hardware device (e.g., a general-purpose processor, a DSP, a CPU, an ASIC, an FPGA, or any combination thereof). In some implementations, the processor 802 may be configured to operate the memory 804. In some other implementations, the memory 804 may be integrated into the processor 802. The processor 802 may be configured to execute computer-readable instructions stored in the memory 804 to cause the NE 800 to perform various functions of the present disclosure.

The memory 804 may include volatile or non-volatile memory. The memory 804 may store computer-readable, computer-executable code including instructions when executed by the processor 802 cause the NE 800 to perform various functions described herein. The code may be stored in a non-transitory computer-readable medium such the memory 804 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 802 and the memory 804 coupled with the processor 802 may be configured to cause the NE 800 to perform various functions (e.g., operations, signaling) described herein (e.g., executing, by the processor 802, instructions stored in the memory 804). In some implementations, the processor 802 may include multiple processors and the memory 804 may include multiple memories. One or more of the multiple processors may be coupled with one or more of the multiple memories, which may be individually or collectively, configured to perform various functions (e.g., operations, signaling) of the NE 800 as described herein.

The processor 802 coupled with the memory 804 may be configured to, capable of, or operable to cause the NE 800 to transmit, to a UE, a configuration indicating a DMRS pattern for a plurality of RBs or a plurality of time slots, or both, where the DMRS pattern comprises different DMRS parameters to be applied across the plurality of RBs or the plurality of time slots, or both; communicate data with the UE (e.g., transmit and/or receive user data or control plane signaling different that an RS transmission) using a transmission grant in accordance with a set of DMRS parameters for each RB or time slot associated with a transmission grant. In certain implementations, the processor 802 coupled with the memory 804 may be configured to, capable of, or operable to cause the NE 800 to determine the set of DMRS parameters for the transmission grant, e.g., based on the DMRS configuration.

In some implementations, the different DMRS parameters to be applied across the plurality of RBs or the plurality of time slots, or both, comprises one or more of: A) differing DMRS symbol positions for the plurality of RBs, B) differing DMRS symbol positions for the plurality of time slots, C) differing DMRS types for the plurality of RBs, D) differing DMRS types for the plurality of time slots, E) differing frequency-domain densities for the plurality of RBs, F) differing frequency-domain densities for the plurality of time slots, G) differing numbers of DMRS symbols for the plurality of RBs, H) differing numbers of DMRS symbols for the plurality of time slots, I) differing DMRS port allocations for the plurality of RBs, J) differing DMRS port allocations for the plurality of time slots, K) differing DMRS scrambling for the plurality of RBs for the plurality of time slots, L) differing DMRS scrambling for the plurality of RBs for the plurality of time slots, M) omission of DMRS in one or more RBs of the DMRS pattern, N) omission of DMRS in one or more time slots of the DMRS pattern, or a combination thereof.

In some implementations, the DMRS pattern is associated with a particular BWP, and the transmission grant is within the particular BWP. In such embodiments, the processor 802 coupled with the memory 804 may be configured to, capable of, or operable to cause the NE 800 to determine the set of DMRS parameters based on the particular BWP associated with the transmission grant.

In some implementations, the configuration indicates a single transmission grant comprising the plurality of RBs and the plurality of time slots, such that the DMRS pattern is associated with the single transmission grant. In such embodiments, the processor 802 coupled with the memory 804 may be configured to, capable of, or operable to cause the NE 800 to determine the set of DMRS parameters based on the received configuration associated with the single transmission grant.

In some implementations, the configuration comprises an indication (e.g., implicit or express) of a number of RBs or time slots in the configuration and a list of DMRS parameter sets. In such implementations, each DMRS parameter set in the list of DMRS parameter sets corresponds to a respective RB or time slot of the DMRS pattern. In certain implementations, the configuration comprises an identifier indicating whether a specific DMRS parameter applies to a next RB or a next time slot. In certain implementations, the configuration comprises an indication of a transition between an RB-level DMRS sub-configuration and a time slot-level DMRS sub-configuration.

In some implementations, the configuration comprises an indication of a number of RBs or time slots in the configuration, a base DMRS configuration, and a list of modifications applicable to each of the plurality of RBs or time slots of the DMRS pattern. In certain implementations, to determine the set of set of DMRS parameters, the processor 802 coupled with the memory 804 may be configured to, capable of, or operable to cause the NE 800 to apply the base DMRS configuration to a first RB in a first time slot associated with the transmission grant and apply the list of modifications to a remainder of the plurality of RBs or time slots of the DMRS pattern. In some implementations, the number of subcarriers in each RB the plurality of RBs is fixed or set by the configuration message.

In some implementations, the configuration defines a cyclic DMRS pattern across a fixed number of RBs or time slots, or both. In such implementations, the processor 802 coupled with the memory 804 may be configured to, capable of, or operable to cause the NE 800 to determine the set of DMRS parameters for each RB or time slot associated with the transmission grant by applying the cyclic DMRS pattern cyclically when the number of scheduled RBs or time slots associated with the transmission grant exceeds the fixed number.

In some implementations, the configuration defines the DMRS pattern across a fixed number of RBs or time slots, or both. In such implementations, the processor 802 coupled with the memory 804 may be configured to, capable of, or operable to cause the NE 800 to determine the set of DMRS parameters for each RB or time slot associated with the transmission grant by applying a portion the DMRS pattern when the number of scheduled RBs or time slots associated with the transmission grant is less than the fixed number.

In some implementations, the DMRS pattern indicates an omission of DMRS of at least some DMRS ports for at least one RB or at least one time slot, or both. In such implementations, the processor 802 coupled with the memory 804 may be configured to, capable of, or operable to cause the NE 800 to communicate the data using one or more resources reserved for DMRS in the at least one RB or at least one time slot where DMRS is omitted.

In some implementations, the NE 800 may further comprise an AI-based receiver configured to receive the data using the determined set of DMRS parameters and perform channel estimation using the determined set of DMRS parameters. For example, the processor 802 coupled with the memory 804 and the transceiver 808 may form the AI-based receiver that receives the data and performs the channel estimation using the determined set of DMRS parameters. In certain implementations, the AI-based receiver receives the data and performs the channel estimation even in cases where the DMRS is omitted in one or more RBs and/or one or more time slots, or where the DMRS patterns varies across RBs or time slots.

The controller 806 may manage input and output signals for the NE 800. The controller 806 may also manage peripherals not integrated into the NE 800. In some implementations, the controller 806 may utilize an operating system such as iOS®, ANDROID®, WINDOWS®, or other operating systems. In some implementations, the controller 806 may be implemented as part of the processor 802.

In some implementations, the NE 800 may include at least one transceiver 808. In some other implementations, the NE 800 may have more than one transceiver 808. The transceiver 808 may represent a wireless transceiver. The transceiver 808 may include one or more receiver chains 810, one or more transmitter chains 812, or a combination thereof.

A receiver chain 810 may be configured to receive signals (e.g., control information, data, packets) over a wireless medium. For example, the receiver chain 810 may include one or more antennas for receiving the signal over the air or wireless medium. The receiver chain 810 may include at least one amplifier (e.g., a low-noise amplifier (LNA)) configured to amplify the received signal. The receiver chain 810 may include at least one demodulator configured to demodulate the received signal and obtain the transmitted data by reversing the modulation technique applied during transmission of the signal. The receiver chain 810 may include at least one decoder for decoding/processing the demodulated signal to receive the transmitted data.

A transmitter chain 812 may be configured to generate and transmit signals (e.g., control information, data, packets). The transmitter chain 812 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 812 may also include at least one power amplifier configured to amplify the modulated signal to an appropriate power level suitable for transmission over the wireless medium. The transmitter chain 812 may also include one or more antennas for transmitting the amplified signal into the air or wireless medium.

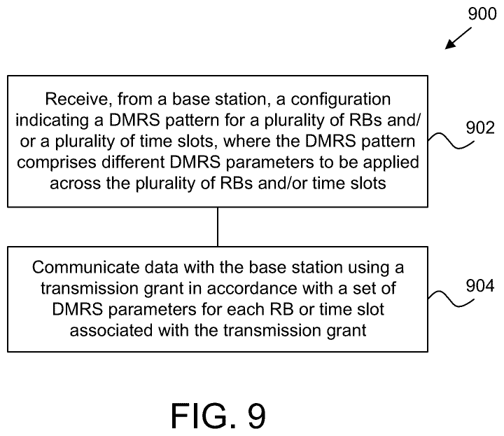

FIG. 9 illustrates a flowchart of a method 900 in accordance with aspects of the present disclosure. The operations of the method 900 may be implemented by a UE as described herein. In some implementations, the UE may execute a set of instructions to control the function elements of the UE to perform the described functions.

At step 902, the method 900 may include receiving, from a base station, a configuration indicating a DMRS pattern for a plurality of RBs and/or a plurality of time slots, where the DMRS pattern comprises different DMRS parameters to be applied across the plurality of RBs and/or the plurality of time slots. In some implementations, aspects of the operations of step 902 may be performed by a UE, as described with reference to FIG. 6.

At step 904, the method 900 may include communicating data with the base station using a transmission grant in accordance with a set of DMRS parameters for each RB or time slot associated with a transmission grant. The operations of step 904 may be performed in accordance with examples as described herein. In some implementations, aspects of the operations of step 904 may be performed by a UE, as described with reference to FIG. 6.

It should be noted that the method 900 described herein describes one possible implementation, and that the operations and the steps may be rearranged or otherwise modified and that other implementations are possible.

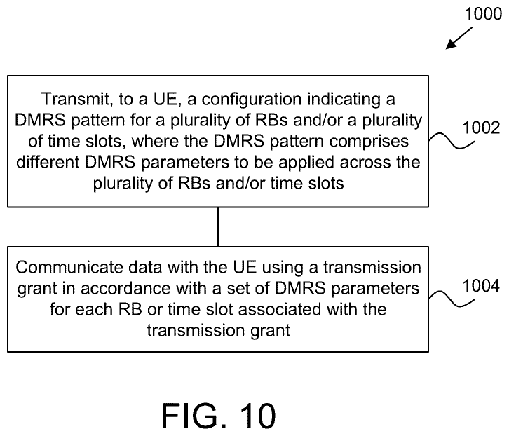

FIG. 10 illustrates a flowchart of a method 1000 in accordance with aspects of the present disclosure. The operations of the method 1000 may be implemented by a base station, such as an NE as described herein. In some implementations, the base station may execute a set of instructions to control the function elements of the base station to perform the described functions.

At step 1002, the method 1000 may include transmitting, to a UE, a configuration indicating a DMRS pattern for a plurality of RBs and/or a plurality of time slots, where the DMRS pattern comprises different DMRS parameters to be applied across the plurality of RBs and/or the plurality of time slots. The operations of step 1002 may be performed in accordance with examples as described herein. In some implementations, aspects of the operations of step 1002 may be performed by a NE, as described with reference to FIG. 8.

At step 1004, the method 1000 may include communicating data with the UE using a transmission grant in accordance with a set of DMRS parameters for each RB or time slot associated with a transmission grant. The operations of step 1004 may be performed in accordance with examples as described herein. In some implementations, aspects of the operations of step 1004 may be performed by a NE, as described with reference to FIG. 8.

It should be noted that the method 1000 described herein describes one possible implementation, and that the operations and the steps may be rearranged or otherwise modified and that other implementations are possible.

What is claimed is:

1. A user equipment (UE) for wireless communication, comprising:
at least one memory; and
at least one processor coupled with the at least one memory and configured to cause the UE to:
receive, from a base station, a configuration indicating a demodulation reference signal (DMRS) pattern for a plurality of resource blocks (RBs) or a plurality of time slots, or both, wherein the DMRS pattern comprises different DMRS parameters to be applied across the plurality of RBs or the plurality of time slots, or both; and
communicate data with the base station using a transmission grant in accordance with a set of DMRS parameters for each RB or time slot associated with the transmission grant.

2. The UE of claim 1, wherein the different DMRS parameters to be applied across the plurality of RBs or the plurality of time slots, or both, comprises one or more of:
differing DMRS symbol positions for the plurality of RBs,
differing DMRS symbol positions for the plurality of time slots,
differing DMRS types for the plurality of RBs,
differing DMRS types for the plurality of time slots,
differing frequency-domain densities for the plurality of RBs,
differing frequency-domain densities for the plurality of time slots,
differing numbers of DMRS symbols for the plurality of RBs,
differing numbers of DMRS symbols for the plurality of time slots,
differing DMRS port allocations for the plurality of RBs,
differing DMRS port allocations for the plurality of time slots,
differing DMRS scrambling for the plurality of RBs for the plurality of time slots,
differing DMRS scrambling for the plurality of RBs for the plurality of time slots,
omission of DMRS in one or more RBs of the DMRS pattern, or
omission of DMRS in one or more time slots of the DMRS pattern.

3. The UE of claim 1, wherein the DMRS pattern is associated with a bandwidth part (BWP) and the transmission grant is within the BWP, and wherein the at least one processor is configured to cause the UE to determine the set of DMRS parameters based on the BWP associated with the transmission grant.

4. The UE of claim 1, wherein the configuration indicates a single transmission grant comprising the plurality of RBs and the plurality of time slots, wherein the DMRS pattern is associated with the single transmission grant.

5. The UE of claim 1, wherein the configuration comprises an indication of a number of RBs or time slots in the configuration and a list of DMRS parameter sets, wherein each DMRS parameter set in the list of DMRS parameter sets corresponds to a respective RB or time slot of the DMRS pattern.

6. The UE of claim 1, wherein the configuration comprises an indication of a number of RBs or time slots in the configuration, a base DMRS configuration, and a list of modifications applicable to each of the plurality of RBs or time slots of the DMRS pattern.

7. The UE of claim 6, wherein the at least one processor is configured to cause the UE to apply the base DMRS configuration to a first RB in a first time slot associated with the transmission grant and apply the list of modifications to a remainder of the plurality of RBs or time slots of the DMRS pattern.

8. The UE of claim 1, wherein each RB the plurality of RBs comprises a number of subcarriers, and wherein the number of subcarriers is fixed or set by the configuration.

9. The UE of claim 1, wherein the configuration defines a cyclic DMRS pattern across a fixed number of RBs or time slots, or both, and wherein the at least one processor is configured to cause the UE to apply the cyclic DMRS pattern cyclically when the number of scheduled RBs or time slots associated with the transmission grant exceeds the fixed number.

10. The UE of claim 1, wherein the configuration defines the DMRS pattern across a fixed number of RBs or time slots, or both, and wherein the at least one processor is configured to cause the UE to apply a portion the DMRS pattern when the number of scheduled RBs or time slots associated with the transmission grant is less than the fixed number.

11. The UE of claim 1, wherein the configuration comprises an identifier indicating whether a specific DMRS parameter applies to a next RB or a next time slot.

12. The UE of claim 1, wherein the configuration comprises an indication of a transition between an RB-level DMRS sub-configuration and a time slot-level DMRS sub-configuration.

13. The UE of claim 1, wherein the DMRS pattern indicates an omission of DMRS of at least some DMRS ports for at least one RB or at least one time slot, or both, and wherein the at least one processor is configured to cause the UE to communicate the data using one or more resources reserved for DMRS in the at least one RB or at least one time slot where DMRS is omitted.

14. The UE of claim 1, further comprising an artificial intelligence (AI) based receiver configured to receive the data using the set of DMRS parameters and perform channel estimation using the set of DMRS parameters.

15. A method performed by a user equipment (UE), the method comprising:
receiving, from a base station, a configuration indicating a demodulation reference signal (DMRS) pattern for a plurality of resource blocks (RBs) or a plurality of time slots, or both, wherein the DMRS pattern comprises different DMRS parameters to be applied across the plurality of RBs or the plurality of time slots, or both; and
communicating data with the base station using a transmission grant in accordance with a set of DMRS parameters for each RB or time slot associated with a transmission grant.

16. A base station for wireless communication, comprising:
at least one memory; and
at least one processor coupled with the at least one memory and configured to cause the base station to:
transmit, to a user equipment (UE), a configuration indicating a demodulation reference signal (DMRS) pattern for a plurality of resource blocks (RBs) or a plurality of time slots, or both, wherein the DMRS pattern comprises different DMRS parameters to be applied across the plurality of RBs or the plurality of time slots, or both; and
communicate data with the UE using a transmission grant in accordance with a set of DMRS parameters for each RB or time slot associated with a transmission grant.

17. The base station of claim 16, wherein the different DMRS parameters to be applied across the plurality of RBs or the plurality of time slots, or both, comprises one or more of:
differing DMRS symbol positions for the plurality of RBs,
differing DMRS symbol positions for the plurality of time slots,
differing DMRS types for the plurality of RBs,
differing DMRS types for the plurality of time slots,
differing frequency-domain densities for the plurality of RBs,
differing frequency-domain densities for the plurality of time slots,
differing numbers of DMRS symbols for the plurality of RBs,
differing numbers of DMRS symbols for the plurality of time slots,
differing DMRS port allocations for the plurality of RBs,
differing DMRS port allocations for the plurality of time slots,
differing DMRS scrambling for the plurality of RBs for the plurality of time slots,
differing DMRS scrambling for the plurality of RBs for the plurality of time slots,
omission of DMRS in one or more RBs of the DMRS pattern, or
omission of DMRS in one or more time slots of the DMRS pattern.

18. The base station of claim 16, wherein the configuration comprises an indication of a number of RBs or time slots in the configuration and a list of DMRS parameter sets, wherein each DMRS parameter set in the list of DMRS parameter sets corresponds to a respective RB or time slot of the DMRS pattern.

19. The base station of claim 16, wherein the configuration comprises an indication of a number of RBs or time slots in the configuration, a DMRS configuration for a first RB in a first time slot associated with the transmission grant, and a list of modifications applicable to a remainder of the plurality of RBs or time slots of the DMRS pattern.

20. A method performed by a base station, the method comprising:
transmitting, to a user equipment (UE), a configuration indicating a demodulation reference signal (DMRS) pattern for a plurality of resource blocks (RBs) within or a plurality of time slots within, or both, wherein the DMRS pattern comprises different DMRS parameters to be applied across the plurality of RBs or the plurality of time slots, or both; and
communicating data with the UE using a transmission grant in accordance with a set of DMRS parameters for each RB or time slot associated with a transmission grant.
